(19) United States
(12) Patent Application Publication
(10) Pub. No.: US 2012/0284093 A1
(43) Pub. Date: Nov. 8, 2012

(54) System and Method For Including Advertisements In Electronic Communications

(76) Inventor: Michael Shepherd Evans, Provo, UT (US)

(21) Appl. No.: 13/460,428

(22) Filed: Apr. 30, 2012

Related U.S. Application Data
(60) Provisional application No. 61/483,526, filed on May 6, 2011.
(60) Provisional application No. 61/576,838, filed on Dec. 16, 2011.

(51) Int. Cl. G06Q 30/02; H04W 4/14

(52) U.S. Cl. 705/14.1; 705/14.4; 705/14.64; 705/14.49; 705/14.58; 705/14.57; 705/14.66

(57) ABSTRACT

Improved techniques for targeting advertisements are provided, which take into account the content of electronic communications delivered via text messaging and/or other forms of communications. The system may automatically select advertisements based on message content, and the selected advertisements may then be displayed alongside messages, and/or embedded in or included in messages, for presentation to the sender and/or recipient of the message. Overall conversational context, including content of past messages between the parties, can be taken into account in selecting advertisements. In at least one embodiment, the content of a displayed advertisement can change dynamically in response to changes in the subject of a text conversation. Senders of messages can be rewarded for allowing advertisements to be embedded and/or displayed in connection with their messages.

### CROSS-REFERENCE TO RELATED APPLICATION

The present application claims priority from U.S. Provisional Application Ser. No. 61/483,526 for “System and Method for Distributing Advertisements via Mobile Communication Devices,” filed May 6, 2011, the disclosure of which is incorporated herein by reference in its entirety.

The present application further claims priority from U.S. Provisional Application Ser. No. 61/576,838 for “System and Method for Including an Advertisement in Electronic Communication,” filed Dec. 16, 2011, the disclosure of which is incorporated herein by reference in its entirety.

### FIELD OF THE INVENTION

The present invention relates to transmission of advertisements, and more particularly to a system and method for including advertisements in electronic communications.

### DESCRIPTION OF THE RELATED ART

Online advertisers often struggle to maximize the effectiveness of their advertisements by attempting to transmit advertisements that are most likely to be of interest to the recipient. Many different techniques are used in such attempts to target advertisements. For example, online advertisers often use data stored in cookies to make determinations as to the likely interests of users (based on past Internet browsing behavior and/or other available information), so as to present advertisements that match those interests. Advertisements may also be presented adjacent to search results on web pages; such advertisements may be targeted based on the user-entered query terms, past browsing behavior, and/or other factors. Some web-based email services, such as Gmail, available from Google Inc. of Mountain View, Calif., present advertisements within a web page adjacent to email messages, wherein such advertisements may be targeted based on the content of the user's email messages.

All of such techniques are limited in their effectiveness, because they are limited to advertisement presentation within the context of a web page as presented on a user's computer. Increasingly, however, users are turning to a variety of communication modes that replace and/or supplement email. Short Message Service (SMS), or “text messaging”, for example, has experienced a significant growth as a communication mode, particularly since it is convenient and accessible on mobile devices, even where an Internet connection is not available. Other instant messaging services available on mobile devices have also become increasingly popular; these include, for example, BlackBerry Messenger, available from Research in Motion Limited of Waterloo, Ontario, Canada, and iMessages, available from Apple Inc. of Cupertino, Calif.

One limitation of existing techniques for targeting advertisements is that these existing techniques fail to take into account the content of electronic communications delivered via increasingly popular modes such as text messaging and other forms of instant messaging.

### SUMMARY

According to various embodiments of the present invention, improved techniques for targeting advertisements are provided, which take into account the content of electronic communications delivered via text messaging and/or other forms of communications such as instant messaging, posts to social networking websites, blogs, and/or the like. The system of the present invention automatically selects advertisements based on message content, and the selected advertisements may then be presented concurrently with messages, and/or embedded in or included in messages, for presentation to the recipient and/or sender of the message. In other embodiments, the selected advertisements may be retrieved and/or received separately from messages, and may be presented to the message recipient and/or sender separately from or together with the message itself. Advertisements may include any suitable elements, such as for example and without limitation: banner advertisements, text, graphics, icons, photographs, interactive elements, web links, animations, videos, and/or any combination thereof. A selected advertisement may be transmitted and/or presented via the same communications mode as the message itself, or via a different communications mode. In at least one embodiment, the content of a displayed advertisement can change dynamically in response to changes in the subject of a text conversation.

In at least one embodiment, the system and method of the present invention are implemented on mobile communication devices, with support and resources provided by one or more servers, which may be located remotely with respect to the communication devices.

In at least one embodiment, the system and method of the present invention include a platform for generating, selecting, transmitting, receiving, and/or presenting advertisements. Such a platform may be implemented as an application programming interface (API) that allows third parties to configure and use the system.

In at least one embodiment, the system and method of the present invention provide a mechanism for intercepting messages, such as text messages or other forms of electronic communication, to include or embed an advertisement within the message. To improve targeting, the system and method of the present invention can, in at least one embodiment, perform analysis on the content of the message, and can select an advertisement based on such content. Other factors may also be taken into account, such as past messages, expressed preferences, geo-location of the user, conversational context, and/or behaviors of the sender, the recipient, and/or other individuals with whom the sender and/or recipient may have a relationship. For example, the known likes and dislikes of a user's “friends” within a social network may be taken into account in selecting advertisements.

Once the system has selected an advertisement, the advertisement is displayed concurrently with the display of a message, and/or embedded in the message being sent to the recipient, and/or sent as a separate message to the recipient along with the original message.

In at least one embodiment, an advertisement is presented on the device of the recipient, concurrently with the display of the message from the sender, for example as a banner advertisement that is displayed while the message from the sender is displayed. In at least one embodiment, this advertisement, or the content therein, may change as the topic of the conversation changes. For example, the system may detect that messages coming from sender are initially about a first topic, and may select content for the displayed advertisement (such as a banner advertisement) to reflect the first topic; if subsequent messages are about a second topic, the system may dynamically change or update the content of the displayed advertisement to reflect the second topic. The process can be repeated for any number of topics that may come up in the course of a text-based conversation between sender and recipient.

In addition, in at least one embodiment, the content of the advertisement can reflect topics as determined from messages initiated by either or both parties in a text-based conversation.

Additional mechanisms for selecting and delivering the advertisement are discussed in more detail herein.

In at least one embodiment, senders of such messages can be rewarded for allowing advertisements to be embedded and/or displayed in connection with their messages. For example, a sender may receive a credit, prize, or other reward, when a recipient is presented with a targeted advertisement that is displayed in connection with one of the sender's messages according to the techniques described herein. Alternatively, the reward can be conferred when the recipient takes some sort of action in connection with the targeted advertisement, for example by clicking on a link therein.

In various embodiments, advertisements may include redeemable coupons, or may include links that cause redeemable coupons to be sent automatically to recipients.

As will become apparent in the description provided herein, various controls and parameters may be provided for configuring the behavior of the described systems and methods, so as to address privacy concerns and to increase the effectiveness of the presented advertisements.

Further details and variations are described herein.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram depicting a communication device for implementing the present invention according to one embodiment of the present invention.

FIG. 2 is a block diagram depicting a system architecture for implementing the present invention according to one embodiment of the present invention.

FIG. 3A is a block diagram depicting a system architecture for inserting advertisements in messages, wherein messages are transmitted via a telephone company's cell phone network, according to one embodiment of the present invention.

FIG. 3B is an event trace diagram depicting a method for inserting advertisements in messages, wherein messages are transmitted via a telephone company's cell phone network, according to one embodiment of the present invention.

FIG. 4A is a block diagram depicting a system architecture for inserting advertisements in messages, wherein messages are transmitted via an app network administered by a third-party service provider, according to one embodiment of the present invention.

FIG. 4B is an event trace diagram depicting a method for inserting advertisements in messages, wherein messages are transmitted via an app network administered by a third-party service provider, according to one embodiment of the present invention.

FIG. 5A is a block diagram depicting a system architecture for inserting advertisements in messages, wherein an application running at the sender's device inserts the advertisements, according to one embodiment of the present invention.

FIG. 5B is an event trace diagram depicting a method for inserting advertisements in messages, wherein an application running at the sender's device inserts the advertisements, according to one embodiment of the present invention.

FIG. 5C is a block diagram depicting a system architecture for inserting advertisements in messages, wherein an application running at the sender's device inserts the advertisements and modified messages are transmitted via an app network administered by a third-party service provider, according to one embodiment of the present invention.

FIG. 5D is an event trace diagram depicting a method for inserting advertisements in messages, wherein an application running at the sender's device inserts the advertisements and modified messages are transmitted via an app network administered by a third-party service provider, according to one embodiment of the present invention.

FIG. 6 is a screen shot depicting an example of automatically inserting an advertisement in a text message, wherein the inserted advertisement includes text, according to one embodiment of the present invention.

FIG. 7 is a screen shot depicting an example of automatically inserting an advertisement in a text message, wherein the inserted advertisement includes a hyperlink, according to one embodiment of the present invention.

FIG. 8 is a screen shot depicting an example of automatically inserting an advertisement in a text message, wherein the inserted advertisement includes both text and a hyperlink, according to one embodiment of the present invention.

FIG. 9 is a screen shot depicting an example of automatically inserting an advertisement in a text message, wherein the inserted advertisement includes a hyperlink having embedded keywords, according to one embodiment of the present invention.

FIG. 10 is a screen shot depicting an example of automatically inserting an advertisement in a text message, wherein the inserted advertisement includes a hyperlink representing a telephone number, according to one embodiment of the present invention.

FIG. 11 is a screen shot depicting an example of automatic transmission of an advertisement in a separate text message accompanying an original text message, according to one embodiment of the present invention.

FIG. 12 is a screen shot depicting an example of a technique of automatically shortening a text message to allow an advertisement to be inserted, according to one embodiment of the present invention.

FIG. 13 is a screen shot depicting an example of a technique of automatically responding to a user's message by presenting an advertisement relevant to keywords found in the message, according to one embodiment of the present invention.

FIGS. 14A and 14B are a series of screen shots depicting an example of a technique of automatically presenting a banner advertisement relevant to a text message conversation, according to one embodiment of the present invention.

FIG. 15 is a screen shot depicting an example of automatically inserting an advertisement in a text message, by converting text of the message to a hyperlink, according to one embodiment of the present invention.

FIGS. 16A through 16C are a series of screen shots depicting an example of automatically transmitting a supplemental text message advertisement, responsive to a user clicking on a link in an advertisement in a text message, according to one embodiment of the present invention.

FIG. 17 depicts an example of an advertisement notification based on geo-fencing, according to one embodiment.

FIG. 18 depicts an example of a list of offers redeemed by “friends” on a social network, according to one embodiment.

FIG. 19 depicts an example of an analytics report as presented by a system of the present invention, according to one embodiment.

### DETAILED DESCRIPTION OF THE EMBODIMENTS

Generally, as described in more detail herein, the system and method of the present invention provide an advertising platform for adding advertisements into electronic communications such as for example and without limitation, short message service (SMS, or “text”) messages, multimedia message service (MMS) messages, blog posts, and the like. For illustrative purposes, the invention is described herein in connection with text messages sent from one mobile device, such as a cell phone or smartphone, to another via a cellular telephone network; however, one skilled in the art will recognize that the techniques of the present invention can be applied to other types of messages and to other communication channels.

In at least one embodiment, the system of the present invention can be implemented in connection with various types of mechanisms for creating and sending messages, including but not limited to native and/or third-party texting applications, websites, blog sites, and the like. As described herein, various embodiments of the present invention provide functionality for intercepting such a message being sent from a sender to a recipient, analyzing the message, selecting one or more advertisements based on the analysis, and adding, inserting or embedding the selected advertisement(s) to be sent to the recipient in or alongside the message. In various configurations, the analysis and selection of advertisement(s) can take into account the content of the message, social network integration, geo-location, conversational history, and/or any other factors, either singly or in any suitable combination. In some embodiments, the sender of a message can be rewarded for allowing advertisements to be added to his or her messages in the manner described herein. Such rewards can be conferred each time a message is sent with an advertisement, or each time a recipient takes action in connection with a received advertisement (by clicking on a link, making a purchase, reading the advertisement, and/or otherwise interacting with the advertisement). Rewards can include points, money, coupons, store credit, and/or any other suitable reward. For example, senders may be paid on a pay-per-click basis; other compensation schemes can be used.

In at least one embodiment, a sender or recipient can receive a reward for re-posting a sent or received message (along with an embedded advertisement) to another forum, such as a social networking website. For example, the person who re-posts such a message may receive credits or other rewards each time a visitor to the website clicks on or otherwise interacts with the message or the advertisement.

In various embodiments, the system of the present invention is able to embed and/or advertisement any of a number of types of advertisements, as described in more detail below.

### System Architecture

According to various embodiments, the present invention can be implemented on any electronic device configured to initiate and/or receive electronic communications. Such an electronic device may be, for example, a cellular telephone, smartphone, desktop computer, laptop computer, personal digital assistant (PDA), music player, handheld computer, tablet computer, kiosk, game system, television, or the like. Such a device may initiate and/or receive electronic communications in any of a number of modes, such as voice, text, email, instant message, chat, video chat, SMS, MMS, and the like. Communications may be implemented via any suitable communications network and according to any known communications protocol. Examples include the Internet, cellular telephone networks, EDGE, 3G, 4G, long term evolution (LTE), Session Initiation Protocol (SIP), Short Message Peer-to-Peer protocol (SMPP), SS7, WiFi, Bluetooth, Hypertext Transfer Protocol (HTTP), Secure Hypertext Transfer Protocol (SHTTP), Transmission Control Protocol/Internet Protocol (TCP/IP), and/or the like, and/or any combination thereof. Communications may be secured, if appropriate, using any known security techniques such as, for example, a Virtual Private Network (VPN). In one embodiment, the system of the present invention can use any appropriate security mechanism(s) to ensure that user information is kept private; such mechanism(s) can include for example, salts, hashes, and/or memCaches (memory caches), either singly or in any suitable combination. Such techniques are well known in the art.

Although the invention is described herein in connection with an implementation involving text messages transmitted from one cell phone (or smartphone) to another, one skilled in the art will recognize that the techniques of the present invention can be implemented in other contexts, and indeed in any suitable device or service that enables electronic communication. Accordingly, the following description is intended to illustrate various embodiments of the invention by way of example, rather than to limit the scope of the claimed invention.

In at least one embodiment, the present invention is implemented as software running on a communication device. Such software can be in the form of an application (or “app”) that can be downloaded (or otherwise obtained) and installed on the device. Alternatively, the functionality of the present invention can be included in software that is bundled with the device, such as operating system software, or delivered as a service to a device running a browser. In other embodiments, as described in more detail below, the system of the present invention can be implemented without any specialized software running on the communication device. For example, the system of the present invention can be implemented in such a manner that a third party, app network, telephone company, or other entity interfaces with a central server running an API that modifies messages to insert advertisements, without any such operations being performed on the communication device itself.

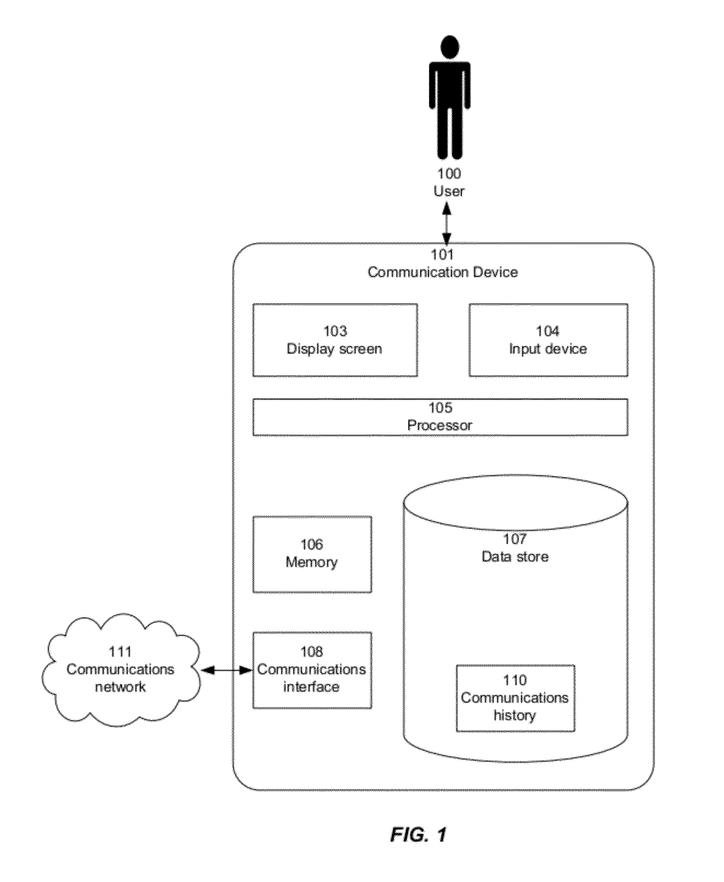

Referring now to FIG. 1, there is shown a block diagram depicting a communication device 101 for implementing the present invention according to one embodiment of the present invention. Device 101 may be any electronic device configured to initiate and/or receive electronic communications; for example, smartphone, cell phone, desktop computer, laptop computer, personal digital assistant (PDA), music player, handheld computer, tablet computer, kiosk, game system, television, or the like. In at least one embodiment, device 101 is an iPhone 4S, available from Apple Inc. of Cupertino, Calif., running an operating system such as iOS, also available from Apple Inc. of Cupertino, Calif.

In at least one embodiment, communication device 101 comprises a number of hardware components as are well known to those skilled in the art. Input device 104 can be a keyboard, mouse, touchscreen, trackball, trackpad, five-way switch, voice input device, joystick, and/or any combination thereof. In embodiments wherein input device 104 is a touchscreen, a virtual keyboard and/or other input elements can be displayed thereon, according to known techniques. Display screen 103 is also provided, for displaying a user interface wherein text messages can be composed and read, and wherein user 100 can read and/or interact with advertisements presented according to the techniques described herein. Device 101 can also include other input and/or output device(s) (not shown), such as a microphone, speaker(s), camera(s), button(s), servomotor (for enabling vibrate alerts), and the like. Device 101 can be controlled in various ways, including voice control, according to well-known means.

Processor 105 can be a conventional microprocessor for performing operations on data under the direction of software, according to well-known techniques. Memory 106 can be random-access memory having a structure and architecture as are known in the art, for use by processor 105 in the course of running software. Communications interface 108 may include any software and/or hardware for enabling communications via communications network 111. Such interface 108 may include a radio, for example, for enabling transmission and reception of data across a cellular telephone network or other wireless network.

Data store 107 can be any magnetic, optical, and/or electrical storage device for storage of data in digital form; examples include flash memory, magnetic hard drive, CD-ROM, and/or the like. In at least one embodiment, data store 107 stores information describing communications history 110 that may be used, in some embodiments, for selecting advertisements to be presented. In at least one embodiment, such information is stored in a database in data store 107. Data store 107 may also contain any other information relevant to the operation of device 101, according to known techniques.

One skilled in the art will recognize that the particular arrangement of hardware elements shown in FIG. 1 is merely exemplary, and that invention can be implemented using different hardware elements configured in any of a number of different ways. Thus, the particular architecture shown in FIG. 1 is merely illustrative and is not intended to limit the scope of the invention in any way. In alternative embodiments, the system of the present invention can be implemented in other ways.

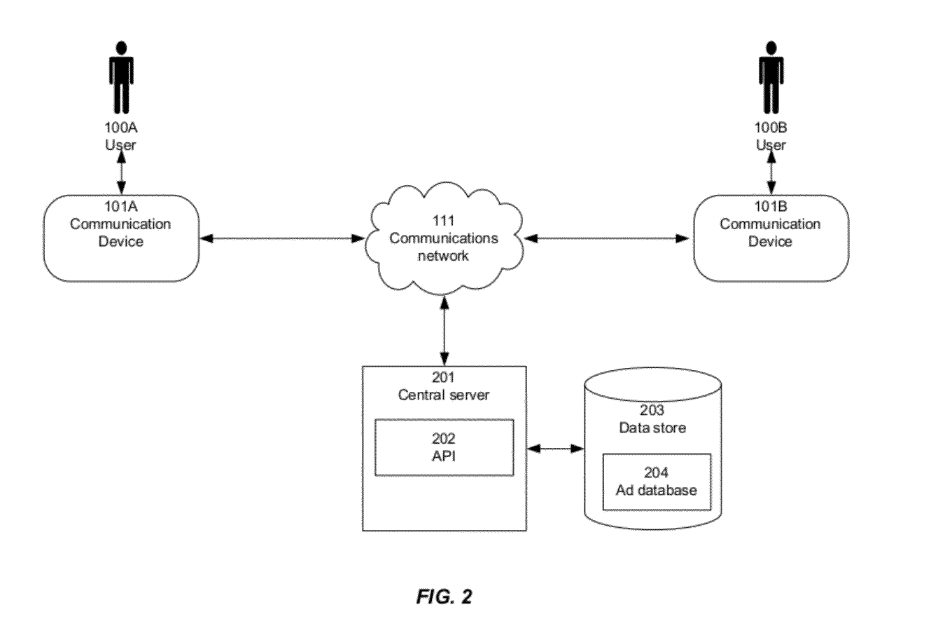

Referring now to FIG. 2, there is shown a system architecture for implementing the present invention according to one embodiment of the present invention. One skilled in the art will recognize that the depicted architecture is merely exemplary, and that the system of the present invention can be implemented using other architectures.

As depicted in FIG. 2, the system of the present invention operates in connection with communications among users 100, such as user 100A and user 100B, via communication devices 101A, 101B. Generally, as described in more detail herein, the system and method of the present invention provide an advertising platform for adding advertisements into electronic communications such as for example and without limitation, short message service (SMS, or “text”) messages, multimedia message service (MMS) messages, blog posts, and the like. Thus, in various embodiments as described herein, the system of the present invention modifies and/or supplements messages (such as text messages) being sent among communication devices 101A, 101B, by inserting advertisements in or alongside such messages. The system of the present invention may select, insert, add, transmit, and/or present advertisements automatically and according to any suitable mechanisms and/or means, examples of which are described in more detail herein.

As described above, communication devices 101A, 101B may include, for example, cell phones, mobile phones, smartphones, personal digital assistants, laptop computers, desktop computers, tablet computers, kiosks, or the like, or they may be any other suitable communication devices. Devices 101A, 101E communicate with one another via communications network 111, which may include, for example, the Internet, cellular telephone networks, EDGE, 3G, 4G, long term evolution (LTE), Session Initiation Protocol (SIP), Short Message Peer-to-Peer protocol (SMPP), SS7, WiFi, Bluetooth, Hypertext Transfer Protocol (HTTP), Secure Hypertext Transfer Protocol (SHTTP), Transmission Control Protocol/Internet Protocol (TCP/IP), and/or the like, and/or any combination thereof. As described in more detail below, central server 201 is also communicatively connected with devices 101A, 101B, via network 111 or via another communications network. Network 111 may be wireless or wired, or any combination thereof. For illustrative purposes, central server 201 is depicted and described herein as a single machine; however it may instead be implemented as a cluster of machines, located in a single location or in multiple locations

In at least one embodiment, an application programming interface (API) 202 runs at central server 201, and performs various steps involved in the operation of the present invention. In at least one embodiment, API 202 is implemented as software for controlling the operation of one or more processors running at central server 201. For example, API 202 may cause central server 201 to modify messages being sent from one user 100A to another user 100B, by inserting or embedding advertisements in such messages, according to techniques described in more detail below. In connection with such operations, central server 201 may retrieve advertisements from advertisement database 204, which may be, for example, stored at a local data 203 or other storage device accessible to central server 201.

The use of an API 202 allows the system of the present invention to operate in connection with any of a number of different messaging platforms, without being restricted to any particular messaging platform. For example, telephone companies, app networks, third-party service providers, and the like can interact with API 202 to cause advertisements to be inserted, embedded, and/or displayed according to the techniques described herein. The system can also operate in connection with social networks and/or other communications systems, such as Twitter, Facebook, or the like. For example, the system can operate to embed advertisements in Twitter messages, so that if a user submits a Twitter message on a topic, a relevant advertisement is automatically embedded in the message.

Additional devices can also be connected to network 111 and may operate in conjunction with the present invention. Such devices are omitted from FIG. 2 for clarity, but may include, for example, peripheral devices, multifunctional peripherals (MFPs), print servers, and the like.

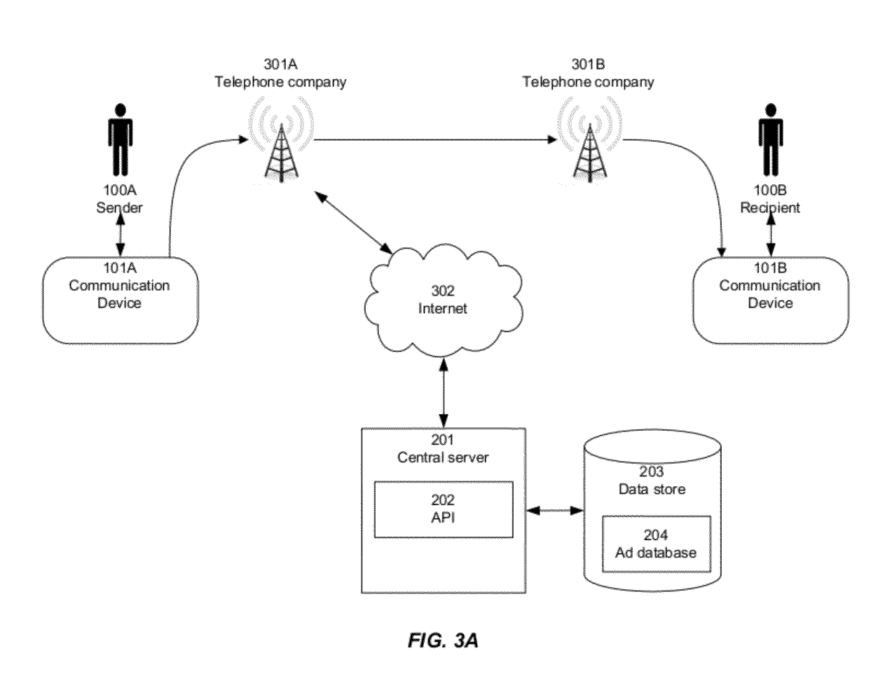

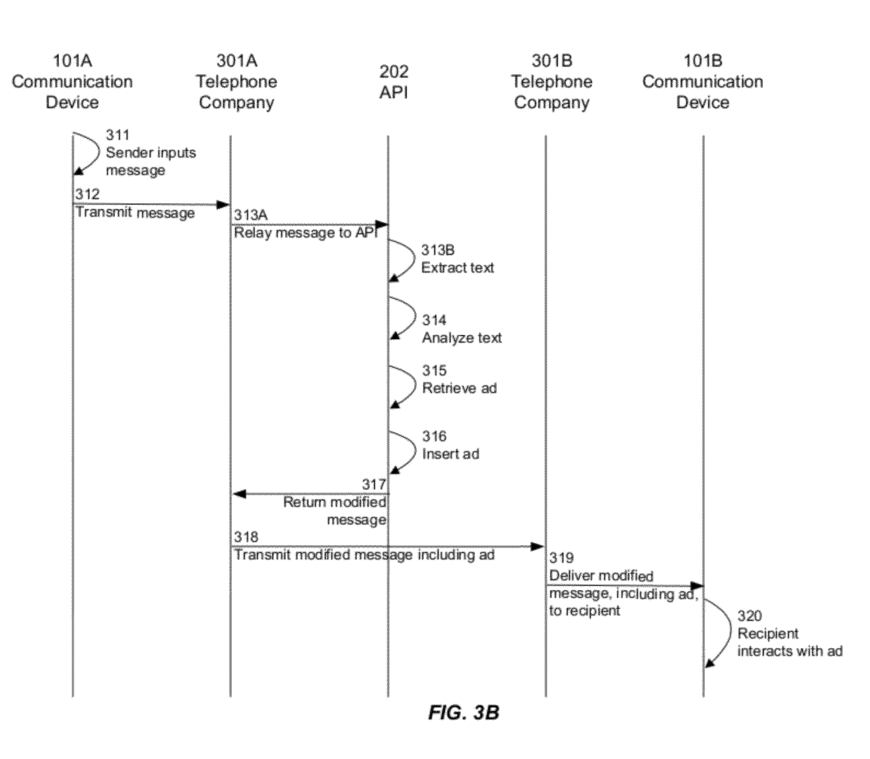

Referring now to FIG. 3A, there is shown a block diagram depicting a system architecture for inserting advertisements in messages, wherein messages are transmitted via a telephone company's 301A cell phone network, according to one embodiment of the present invention. Referring also to FIG. 3B, there is shown an event trace diagram depicting a method for inserting advertisements in messages, wherein messages are transmitted via a telephone company's 301A cell phone network, according to one embodiment of the present invention.

In the architecture shown in FIG. 3A, sender 100A and recipient 100B are users of communication devices 101A, 101B, respectively. For illustrative purposes, devices 101A, 101B are shown as being associated with two different telephone companies 301A, 301B, respectively, though they could be associated with the same telephone company. Such telephone companies may include any company having an infrastructure for handling text-based communications via, for example a wireless network. Examples include those networks provided by AT&T Inc., of Dallas, Tex.; Verizon Communications Inc. of New York, N.Y.; Sprint, and the like. In this embodiment, telephone company 101A can be affiliated with the advertising system implemented on central server 201; thus, telephone company 101A can recognize the message as coming from sender 100A who is a user of the advertising system of the present invention, and can route messages from such a user to central server 201 for analysis and modification thereon.

Sender 100A inputs 311 a message, such as a text-based communication, to be sent to recipient 100B, for example by entering text in a messaging application on device 101A. Sender 100A specifies a unique identifier for recipient 100B, such as a telephone number, and hits a “send” button. The message is transmitted 312 to telephone company 301A.

Conventionally, such a message would be transmitted via telephone company 301A to telephone company 301B, for delivery at device 101E associated with recipient 100B; such communication can travel via known mechanisms for transmission of text messages. Here, however, telephone company 301A recognizes the message as coming from sender 100A who is a user of the advertising system of the present invention. Thus, according to one embodiment of the present invention, before transmitting the message to telephone company 301B, telephone company 301A relays 313A the message to API 202 running at central server 201 for analysis. Telephone company 301A may also transmit any other known and relevant information concerning the message, sender 100A, and/or recipient 100B, including for example geo-location, conversational history, social networking relationships, purchase history, and the like. Transmission 313A may take place over any suitable communications network, such as for example the Internet 302. Alternatively, telephone company 301A may transmit the entire message to API 202 for extraction and processing thereon.

API 202 running at server 201 extracts 313B relevant text from the received message, analyzes 314 the extracted text, and retrieves 315 an advertisement from advertisement database 204 at data store 203. API 202 modifies the text message by adding, inserting, or embedding 316 the selected advertisement, and returns 317 the modified message to telephone company 301A via the Internet 302 or other suitable network. Once telephone company 301A has received the modified message, it transmits it 318 to telephone company 301B for delivery 319 to communication device 101B. Telephone company 301B need not be affiliated with or be aware of the advertising system implemented on central server 201, since the message has already been modified by the time it reaches telephone company 301B, which can therefore treat it as an ordinary message and deliver it to recipient 100B in a conventional manner. Recipient 100B then views the message, which now includes (or is accompanied by) the selected advertisement. Sender 100A may receive a reward when recipient 100B views or interacts with 320 the advertisement.

In some embodiments, senders 100A can be compensated or rewarded for permitting advertisements to be added to their messages. For example, senders 100A may be paid on a pay-per-click basis; other compensation schemes can be used.

In at least one embodiment, as described in more detail below, a banner advertisement (or other type of advertisement) can be presented on sender's 100A device 101A, based on the content of sender's 100A message and/or based on the content of previous messages between sender 100A and recipient 100A. In such an embodiment, content for such an advertisement is transmitted from API 202 to device 101A; such transmission can be direct, or it can be relayed through telephone company 301A. In response to receiving such content, device 101A causes the advertisement to be displayed in a banner or in another suitable form. As described in more detail below, such advertisements can be periodically updated based on the content of text conversations between sender 100A and recipient 100A.

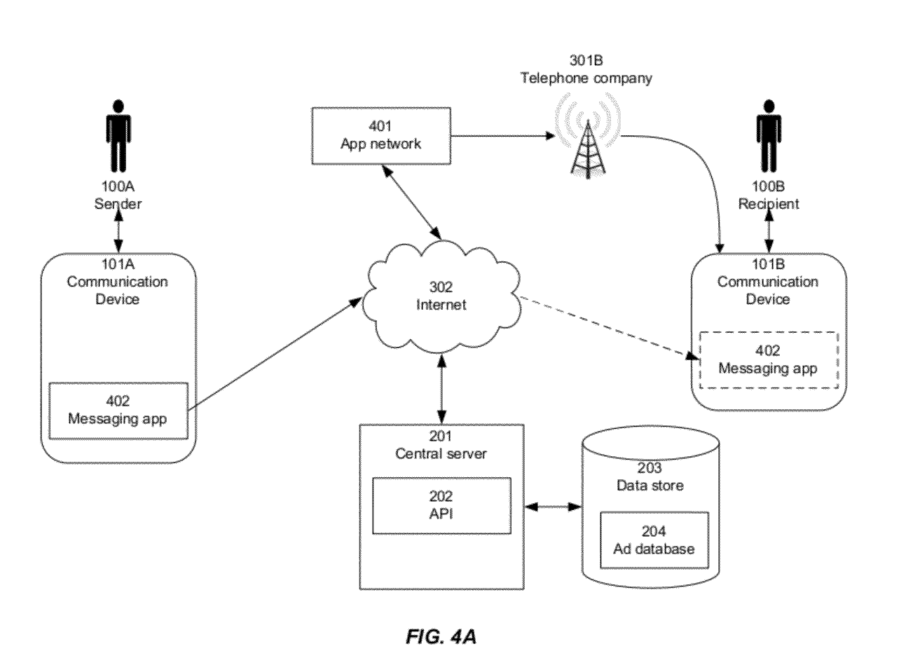

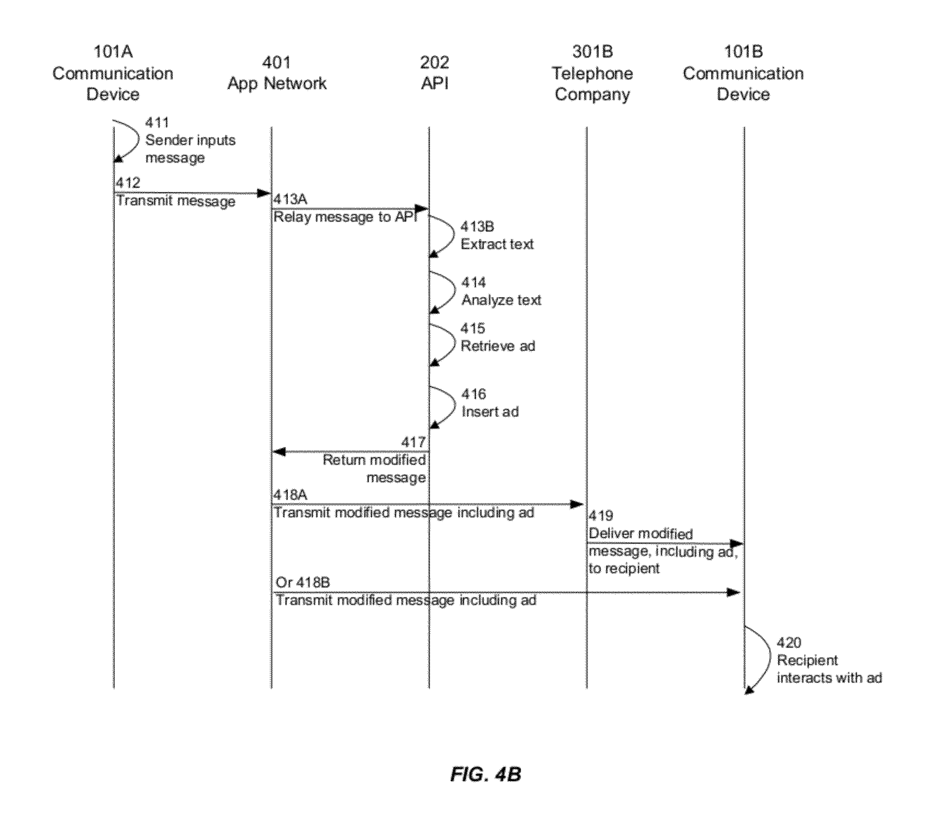

Referring now to FIG. 4A, there is shown is a block diagram depicting a system architecture for inserting advertisements in messages, wherein messages are transmitted via an app network administered by a third-party service provider, according to one embodiment of the present invention. Referring also to FIG. 4B, there is shown an event trace diagram depicting a method for inserting advertisements in messages, wherein messages are transmitted via an app network administered by a third-party service provider, according to one embodiment of the present invention.

Such an embodiment may involve the use of an application 402 running on device 101A that transmits instant messages, such as text messages, to recipients via the Internet. In order to implement the techniques of the present invention, the application is designed to communicate with API 202 running on central server 201. Thus, rather than telephone company 301A communicating with API 202, as was the case in the architecture of FIG. 3A, the application running on device 101A transmits the message for analysis to API 202. Thus, no involvement cooperation is required on the part of either telephone company 301A or 301B.

Third-party service providers for handling text messages, instant messages, and other forms of communication, are well known. Typically, such service providers provide mechanisms for entering and transmitting such messages in a manner that bypasses text-messaging channels of telephone companies 301. Such mechanisms may be provided as applications 402 running on a smartphone or other device, or by any other suitable means. Communications may take place over a data network such as the Internet, 3G, and/or other network, thereby bypassing traditional text-messaging channels and avoiding per-message rates often imposed by telephone companies 301. Examples of such message-handling systems include, for example, TextFree, available from Pinger, Inc. of San Jose, Calif.; BlackBerry Messenger, available from Research in Motion Limited of Waterloo, Ontario, Canada; and iMessages, available from Apple Inc. of Cupertino, Calif. App network 401 implements the central functionality involved in receiving messages from senders via the Internet, and relaying such messages to telephone companies by text-messaging channels. Alternatively, if a message can be sent directly to communication device 101E without using telephone company 301B, app network 401 may transmit messages directly, for example via the Internet 302. In one embodiment, a messaging app 402 (or an affiliated software application) runs on communication device 101B to facilitate such direct transmission of messages from app network 401 to communication device 101B.

In the architecture shown in FIG. 4A, sender 100A and recipient 100B are users of communication devices 101A, 101B, respectively. Device 101A may or may not be associated with a telephone company, but such association is omitted from FIG. 4A because it is not relevant to the communication path depicted in this embodiment. Rather, a text message sent by sender 100A is transmitted from messaging app 402 via the Internet 302 to app network 401, which relays it to communication device 101E via telephone company 301B, for presentation to recipient 100B. Telephone company 301B need not affiliated in any way with the advertising system described herein, since it merely relays the message it receives from app network 401, which already includes advertisement(s), as will be described below. App network 401 can be any conventional network for handling instant messages according to well known techniques.

In this embodiment, app network 401 can be affiliated with the advertising system implemented on central server 201; thus, app network 401 can recognize the message as coming from sender 100A who is a user of the advertising system of the present invention, and can route messages from such a user to central server 201 for analysis and modification thereon.

Sender 100A inputs 411 a message, such as a text-based communication, to be sent to recipient 100B, for example by entering text in messaging app 402 on device 101A. Sender 100A specifies a unique identifier for recipient 100B, such as a handle, email address, telephone number, or the like, and hits a “send” button. The message is transmitted 412 to app network 401 via the Internet 302 or via any suitable communications network.

App network 401 recognizes the message as coming from sender 100A who is a user of the advertising system of the present invention. Thus, according to one embodiment of the present invention, app network 401 relays 413A the message to API 202 running at central server 201 for analysis. App network 401 may also transmit any other known and relevant information concerning the message, sender 100A, and/or recipient 100B, including for example geolocation, conversational history, social networking relationships, purchase history, and the like. Transmission 413A may take place over any suitable communications network, such as for example the Internet 302. In some embodiments, the intermediate step of transmitting the message to app network 401 can be omitted, and the message can be transmitted directly from device 101A to API 202.

API 202 running at server 201 extracts 413B relevant text from the received message, analyzes 414 the extracted text, and retrieves 415 an advertisement from advertisement database 204 at data store 203. API 202 modifies the text message by adding, inserting, or embedding 416 the selected advertisement, and returns 417 the modified message to app network 401 via the Internet 302 or other suitable network. Once app network 401 has received the modified message, it transmits it to communication device 101B. Such communication can take place according to any suitable channel. For example, in at least one embodiment, if the intended recipient 100B is specified as an address of a device associated with telephone company 301B (for example, as a telephone number), app network 401 can transmit 418A the modified message to telephone company 301B, which delivers 419 the message (including advertisement(s)) to communication device 101B via a text-messaging channel. Alternatively, if the intended recipient 100B is specified as an address of the third-party messaging provider, so that an application at communication device 101B allows for the receipt of messages directly from app network 401, app network 401 can transmit 418B the modified message (including advertisement(s)) directly to communication device 101B, without using telephone company 301B. Such direct transmission can take place via the Internet 302 and/or via any suitable data network.

Recipient 100B then views the message, which now includes (or is accompanied by) the selected advertisement. As described above, sender 100A may receive a reward when recipient 100B views or interacts with 420 the advertisement.

As described above in connection with FIG. 3B, in at least one embodiment, a banner advertisement (or other type of advertisement) can be presented on sender's 100A device 101A, based on the content of sender's 100A message and/or based on the content of previous messages between sender 100A and recipient 100A. In such an embodiment, content for such an advertisement is transmitted from API 202 to device 101A; such transmission can be direct, or it can be relayed through app network 401. In response to receiving such content, device 101A causes the advertisement to be displayed in a banner or in another suitable form.

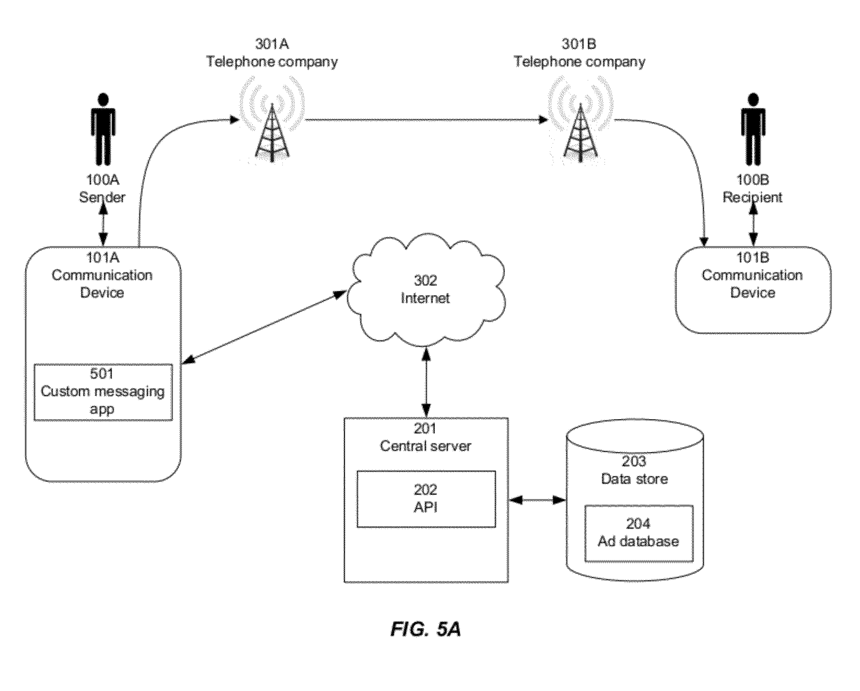

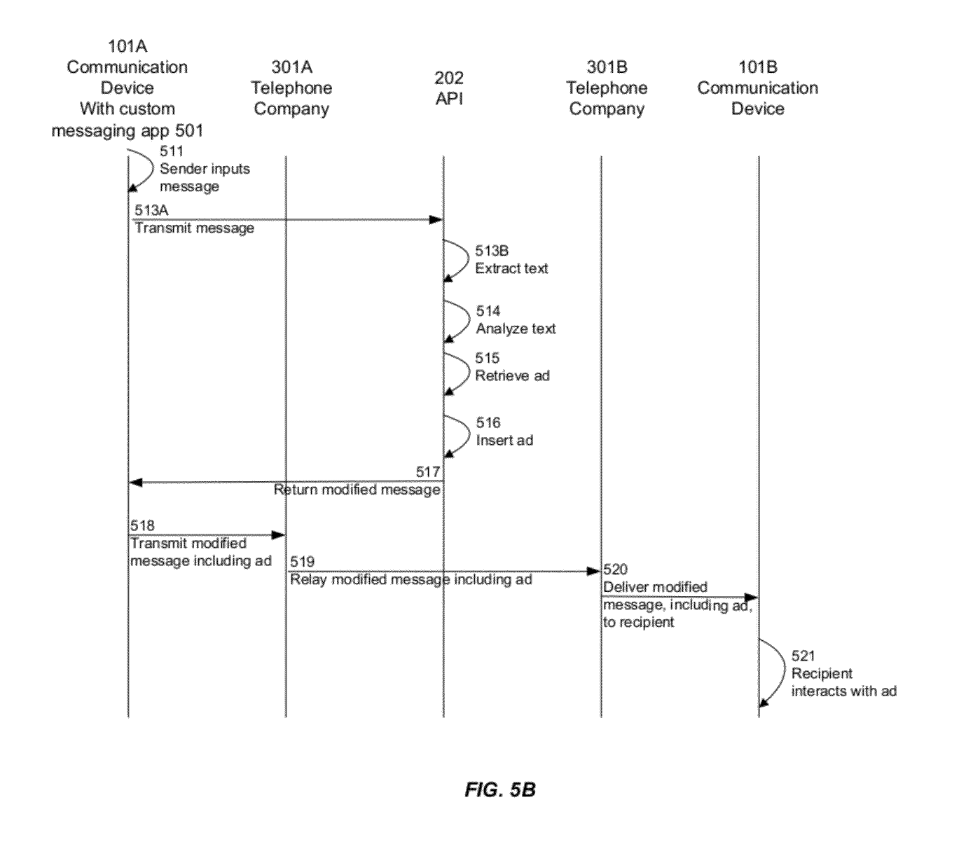

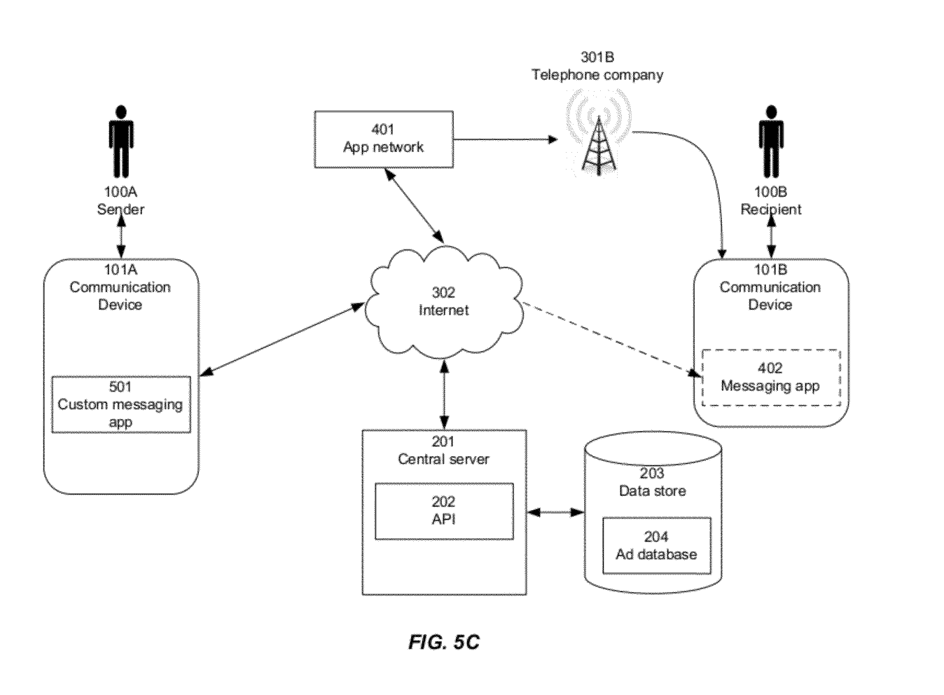

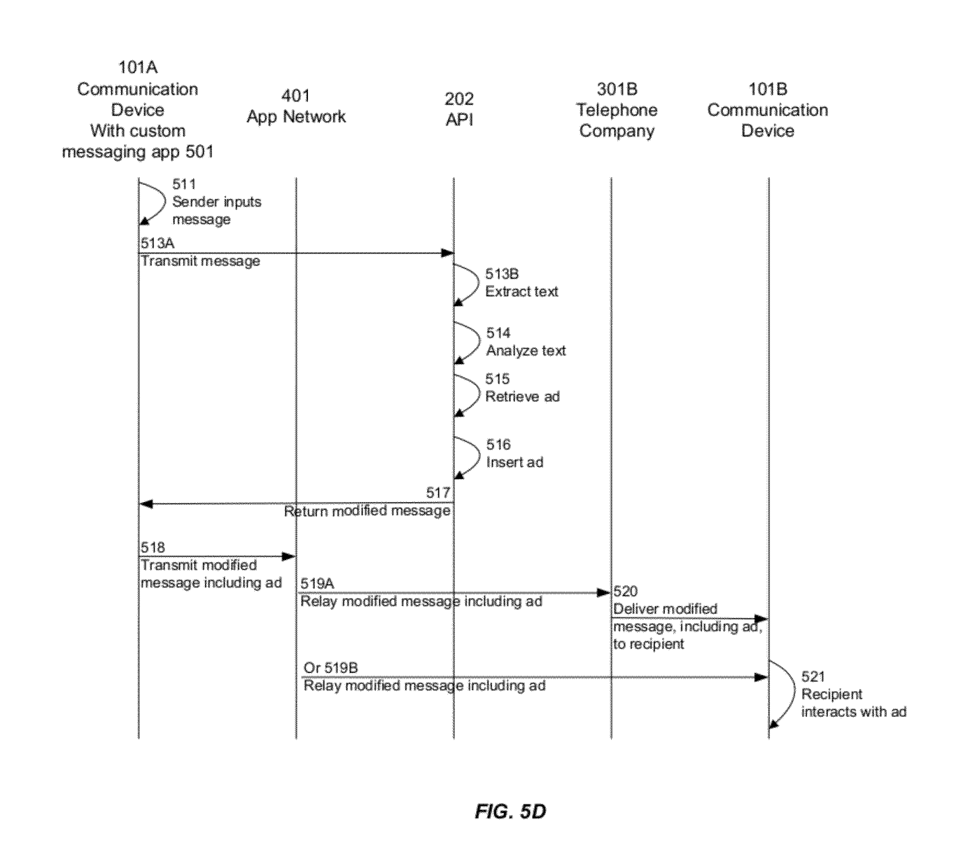

Referring now to FIG. 5A, there is shown is a block diagram depicting a system architecture for inserting advertisements in messages, wherein a custom messaging application 501 running at sender's device 101A inserts the advertisements, according to one embodiment of the present invention. Referring also to FIG. 5B, there is shown an event trace diagram depicting a corresponding method for inserting advertisements in messages.

As with the architecture and method depicted in FIGS. 4A and 4B, respectively, the embodiment depicted in FIGS. 5A and 5B involves the use of an application running on device 101A that transmits instant messages, such as text messages, to recipients via the Internet. Here, however, the application is a custom messaging application 501 that is designed to send the message (and/or other relevant information concerning the message) to API 202 running at central server 202 before the message is transmitted for delivery to recipient 100B. Thus, rather than telephone company 301A or app network 401 communicating with API 202, as was the case in the architectures of FIG. 3A and 4A, respectively, here custom application 501 running on device 101A transmits the message for analysis to API 202. Thus, no involvement or cooperation is required on the part of either telephone company 301A or 301B, or on the part of an app network 401.

Sender 100A inputs 511 a message, such as a text-based communication, to be sent to recipient 100B, for example by entering text in messaging app 402 on device 101A. Sender 100A specifies a unique identifier for recipient 100B, such as a handle, email address, telephone number, or the like, and hits a “send” button. Custom messaging app 501 transmits 513A the message API 202 running at central server 201 for analysis. Custom messaging app 501 may also transmit any other known and relevant information concerning the message, sender 100A, and/or recipient 100B, including for example geo-location, conversational history, social networking relationships, purchase history, and the like. Transmission 513A may take place over any suitable communications network, such as for example the Internet 302. Sender 100A need not be aware that such transmission 513A to API 202 is taking place; indeed, from sender's 100A point of view, the message may appear to be sent normally; the processing involved in adding advertisements need not be visible to sender 100A.

API 202 running at server 201 extracts 513B relevant text from the received message, analyzes 514 the received information and selects and retrieves 515 an advertisement from advertisement database 204 at data store 203. API 202 modifies the text message by adding, inserting, or embedding 516 the selected advertisement, and returns 517 the modified message to custom messaging app 501 via the Internet 302 or other suitable network. Alternatively, API 202 can transmit the advertisement (or a description of the advertisement) to custom messaging app 501, and app 501 can modify the message locally, using such information.

Once custom messaging app 501 has received (or generated) the modified message, it transmits it to communication device 101B according to any conventional messaging channel. In the architecture shown in FIG. 5A, communication devices 101A, 101B are shown as being associated with two different telephone companies 301A, 301B. Thus, the modified message is transmitted 518 to telephone company 101A, relayed 519 to telephone company 101B, and delivered 520 to device 101B. Neither telephone company 301A, 301B need be affiliated in any way with the advertising system described herein, since they merely relay messages that have been customized by custom messaging app 501 to include advertisement(s).

Recipient 100B then views the message, which now includes (or is accompanied by) the selected advertisement, and can interact 521 with the advertisement on device 101B. As described above, sender 100A may receive a reward when recipient 100B views or interacts with 420 the advertisement.

As described above, any suitable messaging channel can be used for delivering the modified message once it has been received by (or generated by) custom messaging app 501. For example, referring now to FIG. 5C, there is shown an alternative embodiment which is similar to that of FIG. 5A, except that messages are sent via an app network 401 after they have been modified by custom messaging app 501. Referring now also to FIG. 5D, there is shown an event trace depicting a series of steps for sending message via an app network 401 using the architecture depicted in FIG. 5C. As described above in connection with FIG. 4A, messages can be sent from app network 401 to device 101B either directly (as shown in step 519B) or via telephone company 301B (as shown in steps 519A and 520). In one embodiment, a messaging app 402 (or an affiliated software application) runs on communication device 101E to facilitate direct transmission of messages from app network 401 to communication device 101B, for example via Internet 302.

As described above in connection with FIGS. 3B and 4B, in at least one embodiment, a banner advertisement (or other type of advertisement) can be presented on sender's 100A device 101A, based on the content of sender's 100A message and/or based on the content of previous messages between sender 100A and recipient 100A. In such an embodiment, content for such an advertisement is transmitted from API 202 to device 101A; such transmission can be direct, or it can be relayed through telephone company 301A or app network 401. In response to receiving such content, device 101A causes the advertisement to be displayed in a banner or in another suitable form.

In any of the above-described embodiments, API 202 makes a determination as to which advertisement should be inserted or embedded into the message being sent to recipient 100B, and/or displayed as a banner ad on device 101A and/or device 101B. Such determination can be made using any suitable techniques. For example, in at least one embodiment, API 202 takes into account the text of the message itself. In at least one embodiment, API 202 can also take into account any suitable factors or information. Examples include, without limitation: text of the message conversation, geo-location, bid price, how previously presented advertisements were received and/or rated, known personality traits of sender 100A and/or recipient 100B, information acquired from a social network such as Facebook, Google+, LinkedIn, or the like, information from the sender, time of day, and the like, as well as the context of the communication. For example, if sender 100A and/or recipient 100B is/are recognized as having sent or received messages previously, or engaged in any other communications, either in the same session or in other sessions, the content of such previous communications can be taken into account when selecting an advertisement. Data from communications history 110 stored at device 101A can be used in making such determinations; accordingly, such data can be transmitted to API 202 along with the text of the message.

Even if a particular message does not indicate the subject matter, an ad relating to that subject matter may be added to or presented along with that message, based on the overall conversational context and/or previous communications between that sender 100A and recipient 100B, or even based on previous communications between that sender 100A and other parties, or that recipient 100B and other parties. For example, sender 100A may send a message of “Yes, definitely”, which contains no indication of the subject matter to which sender 100A is referring. The system of the present invention may determine, however, that a previous text message from recipient 100B to sender 100A inquired as to whether sender 100A intends to go camping this weekend. Based on the overall conversational context, therefore, the system of the present invention determines that “Yes, definitely” refers to camping; thus, the system may present a camping-related advertisement in connection with the “Yes, definitely” message.

Similarly, an advertisement can be added to (or presented with) a content-ambiguous message such as “How are things?”, based on recipient's 100B and/or sender's 100A previous communications with each other and/or with others. If, for example, the system determines that a previous communication revealed that recipient 100B was interested in camping, the system may present a camping-related advertisement in connection with the “How are things?” message.

The previous communications can be in the same mode (such as text messages) as the current message being sent, or they can be in other modes. In at least one embodiment, the system of the present invention can associate messages sent in other channels (such as email messages, blog posts, Twitter messages (“tweets”), Facebook messages, and the like) with the current message, for example by identifying the same sender 100A and/or recipient 100B. Any relevant information about such previously communications can be used to inform the decision as to which advertisement to select. Such information can include the geo-location of the sender 100A and/or recipient 100B, time of day the message was sent, and the like. API 202 can also take into account other behavior of sender 100A and/or recipient 100B, such as purchases, reading material, travel habits, and the like. API 202 can also take into account information gleaned from social networks, for example to determine that sender 100A and/or recipient 100B enjoy a particular type of food, restaurant, television show, or the like.

For example, if API 202 is made aware of email messages previously sent by sender 100A to recipient 100B on the topic of fine wines, it can select a wine-related advertisement to be inserted in a text message from sender 100A to recipient 100B, even if the current text message does not mention wine. As another example, API 202 may determine, based on previous behavior, that sender 100A and recipient 100B tend to go out to movies on Sunday nights, and can select a movie-related advertisement to be inserted in a text message from sender 100A to recipient 100B, even if the current text message does not mention movies. The advertisement can be targeted based on the current location of sender 100A and/or recipient 100B, for example to include a link to showtimes in the area.

In at least one embodiment, API 202 generates a score for various elements of messages to determine whether and when to include an advertisement, and to determine which advertisement to include.

### Modifying Messages to Include Advertisements

In the various embodiments described above, messages sent by sender 100A to recipient 100B are modified to include advertisements. Such advertisements can be presented within messages or they may be sent separately. One skilled in the art will recognize that there are many different ways to modify messages to include advertisements. Some examples will be presented here for illustrative purposes only. Although many of these examples are set forth in the context of modifications made to text messages, one skilled in the art will recognize that these techniques can be applied to messages of other types as well, including for example and without limitation, email messages, multimedia messages, voicemail messages, blog postings, chat messages, and the like.

### Text

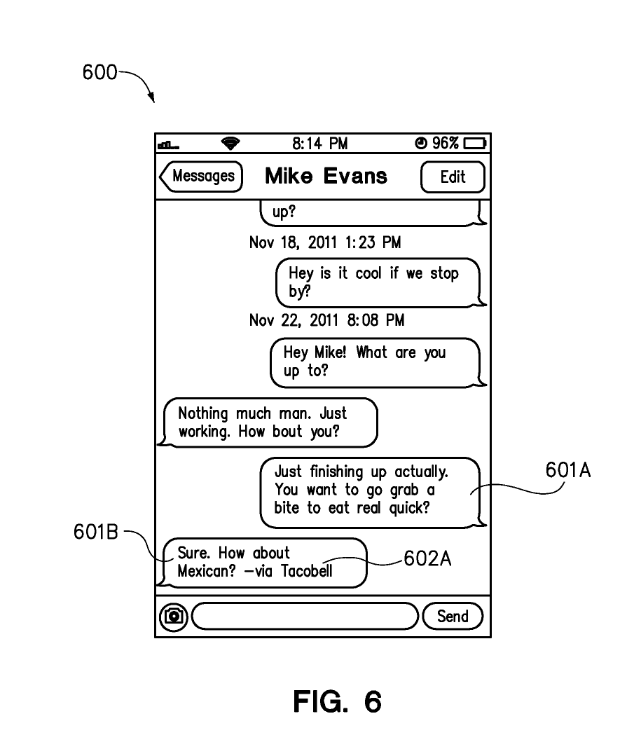

Referring now to FIG. 6, there is shown a screen shot 600, as it might appear on screen 103 of device 101, depicting an example of automatically inserting an advertisement in a text message, wherein the inserted advertisement 602A includes text, according to one embodiment of the present invention. An analysis of the text of message 601A and/or message 601B reveals that the parties involved in the communication are interested in going out for a meal, and are particularly interested in Mexican food. Accordingly, message 601B has been modified, using the techniques of the present invention, to add an advertisement 602A in the form of text “-via Tacobell”. This advertising text is appended to the original text of message 601B, subject to the normal limitations of text message length (such as 160 characters), if applicable.

An advertisement 602A of this type can be used to convey brand awareness, and can therefore be referred to as an “impression” advertisement, or post-text impression (PTI). A hyphen and/or other punctuation can precede the advertisement text, to differentiate it from the original message. Words such as “via,” , “by,” “brought to you by,” and the like, can (but need not) precede the advertisement text. If applicable, an action word or verb can be used; for example, “Drink Coke” or “Eat Tacobell.” Alternatively, the advertisement 602A can be presented without any words or punctuation to set it off from the original text of message 601B.

### Hyperlink

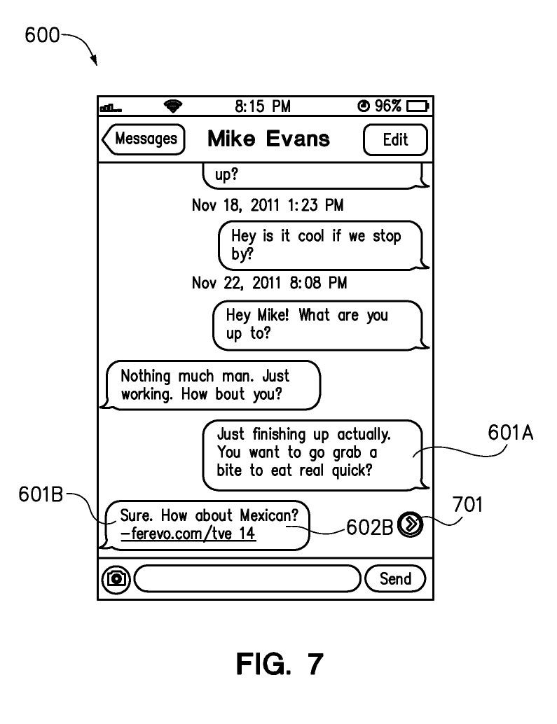

Referring now to FIG. 7, there is shown a screen shot 600, as it might appear on screen 103 of device 101, depicting an example of automatically inserting an advertisement in a text message, wherein the inserted advertisement 602B includes a hyperlink, according to one embodiment of the present invention. Again, it is determined that the parties involved in the communication are interested in going out for a meal, and are particularly interested in Mexican food. Here, message 601B has been modified, using the techniques of the present invention, to add an advertisement 602B in the form of a hyperlink. This hyperlink is appended to the original text of message 601B, subject to the normal limitations of text message length (such as 160 characters), if applicable.

Clicking on hyperlink advertisement 602B takes the user (recipient 100B) provides more information describing the advertised product or service, or otherwise providing recipient 100B with useful information. In order to conserve characters, hyperlink 602B may be a shortened URL that automatically redirects the individual to the appropriate website. Alternatively, hyperlink 602B may be an ordinary link to the advertiser's website.

For example, clicking on advertisement 602B may take recipient 100B to a website describing the advertised product or service, or may play a video depicting the advertised product or service. In another embodiment, clicking on hyperlink advertisement 602B causes a message containing additional information, and/or an offer or coupon, to be sent to recipient 100B, as described in more detail below.

In at least one embodiment, on-screen button 701 provides an alternative way for recipient 100B to activate hyperlink 602B.

### Text and Hyperlink

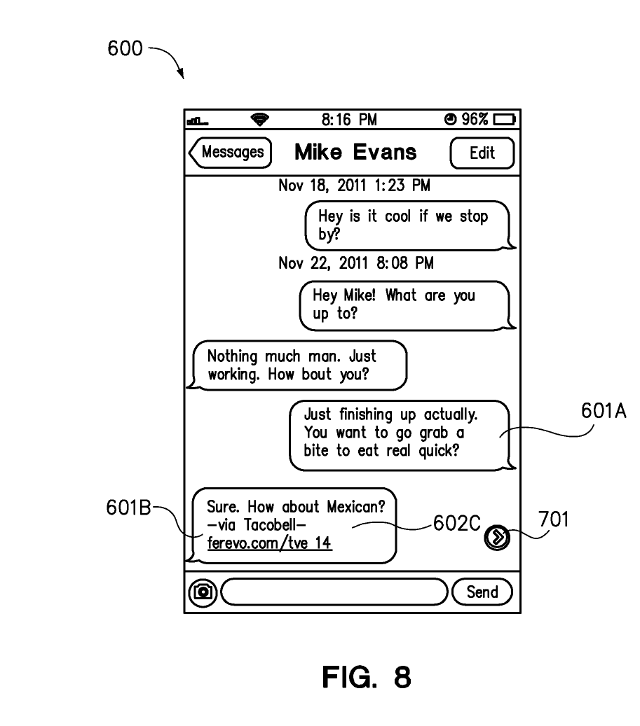

Referring now to FIG. 8, there is shown a screen shot 600, as it might appear on screen 103 of device 101, depicting an example of automatically inserting an advertisement in a text message, wherein the inserted advertisement 602C includes both text and a hyperlink, according to one embodiment of the present invention. The text provides an impression, and may or may not be set off from the original text message as described above in connection with FIG. 6. The hyperlink operates as described above in connection with FIG. 7.

Hyperlink with Embedded Keywords

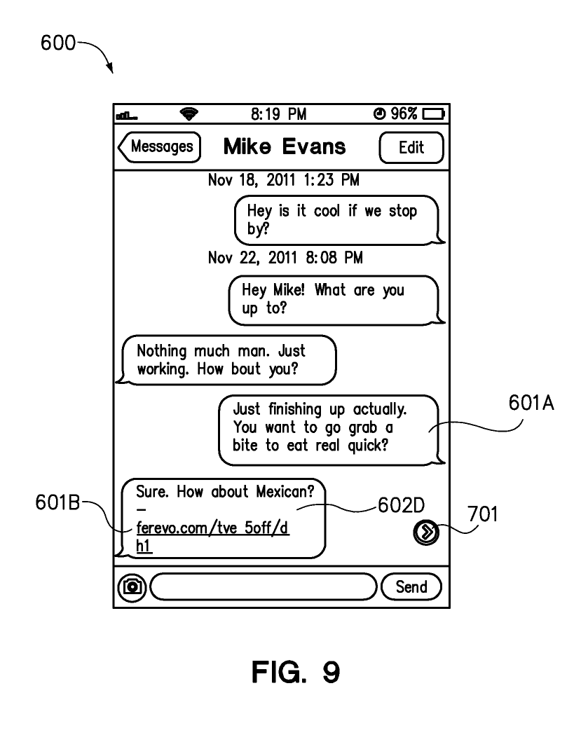

In some cases, it may be useful for the hyperlink itself to contain keywords that provide recipient 100B with an indication of where the hyperlink will take them. Referring now to FIG. 9, there is shown a screen shot 600, as it might appear on screen 103 of device 101, depicting an example of automatically inserting an advertisement in a text message, wherein the inserted advertisement 602D includes a hyperlink having embedded keywords, according to one embodiment of the present invention. In this example, the hyperlink includes the string “tacobell”, giving recipient 100B an indication that clicking on the link will take him or her to the Taco Bell website.

### Hyperlink Representing Telephone Number

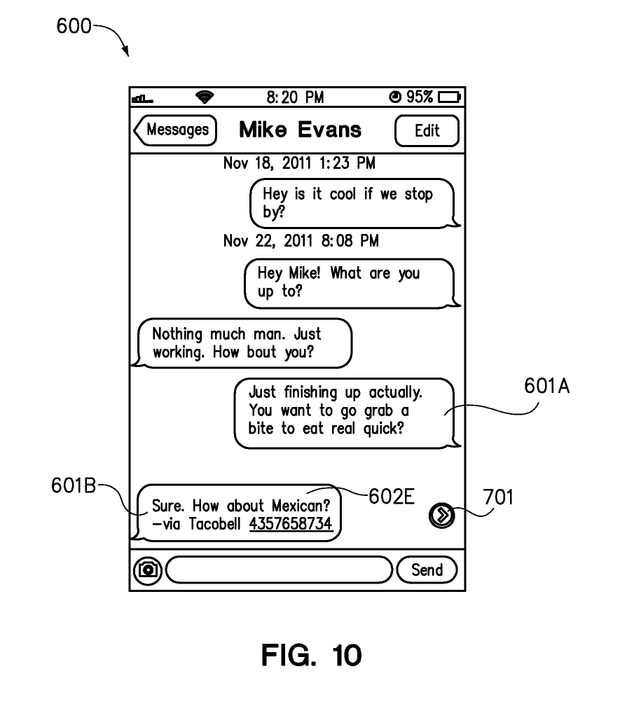

Referring now to FIG. 10, there is shown a screen shot 600, as it might appear on screen 103 of device 101, depicting an example of automatically inserting an advertisement in a text message, wherein the inserted advertisement 602E includes a hyperlink representing a telephone number, according to one embodiment of the present invention. Clicking on the hyperlink causes the telephone number to be dialed automatically on recipient's 100B device. This provides a way for recipient 100B to directly call the advertiser. As shown in FIG. 10, the hyperlink can be accompanied by text, which may help to identify the advertiser.

### Advertisement Transmitted Separately

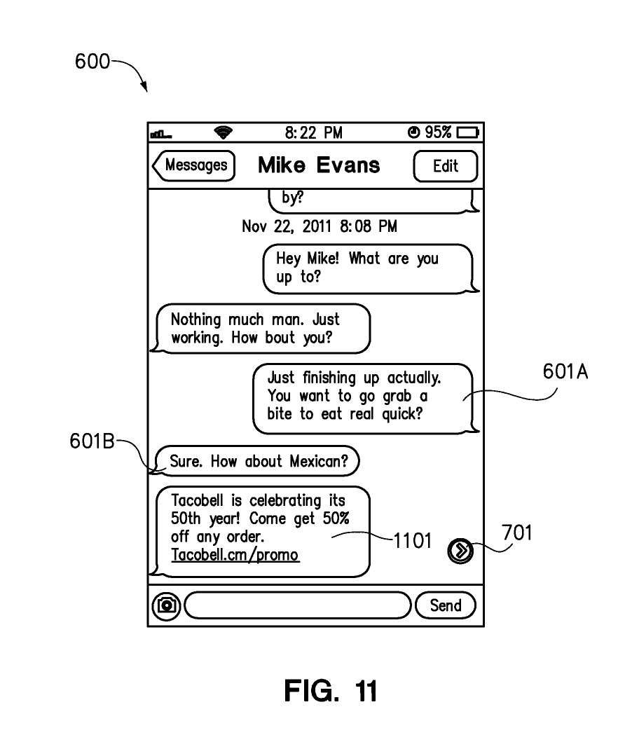

In some cases, it may be useful to transmit the advertisement as a separate message rather than embedded in the original message. Such a variation may be useful, for example if the advertisement is too long to fit within the original message, given applicable limitations on message length. Alternatively, advertisers may wish to have their advertisements stand out by being sent separately. Referring now to FIG. 11, there is shown a screen shot 600, as it might appear on screen 103 of device 101, depicting an example of automatic transmission of an advertisement in a separate text message 1101 accompanying an original text message 601B, according to one embodiment of the present invention. Text message 1101 containing the advertisement can appear before or after original text message 601B.

In at least one embodiment, this technique can be used in combination with any of the other techniques described herein. For example, the original message can be modified to include additional text, hyperlink, or the like, and a supplemental text message 1101 containing a longer advertisement can also be sent.

### Converting Text to Hyperlink

In at least one embodiment, text within a message is converted to a link, wherein the link directs a user to an advertiser's web page or otherwise causes advertiser content to appear. The selection as to what text is converted, and where the link will point, can depend upon the text of the message, the overall text of the conversation, and/or any other relevant factors including, for example, geographic location, previous browsing and/or messaging history, known information about the user and/or sender, or the like.

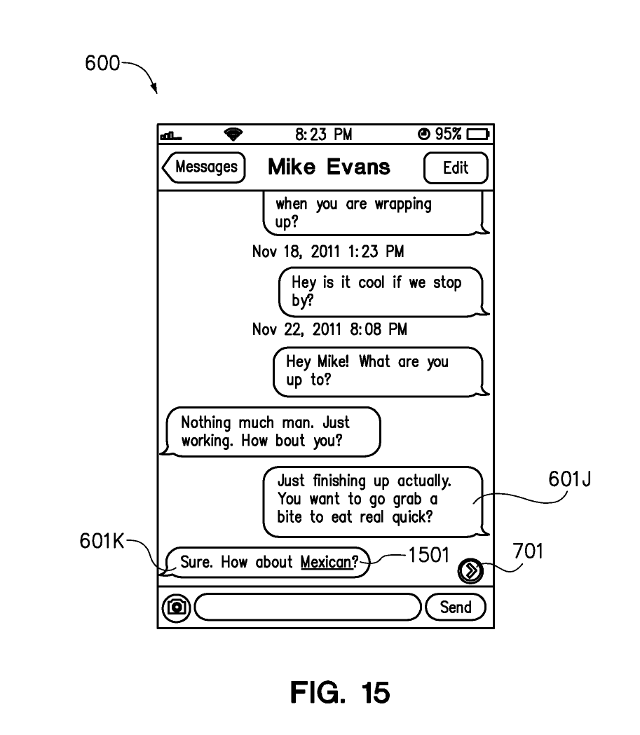

Referring now to FIG. 15, there is shown a screen shot 600, as it might appear on screen 103 of device 101, depicting an example of automatically inserting an advertisement in a text message, by converting text of a message 601K to a hyperlink 1501, according to one embodiment of the present invention. Here, sender 100A sends the message 601K “Sure. How bout Mexican?” in response to recipient's 100B message 601J. Based on an analysis of the content of message 601K, and possibly on other information such as the overall content of the message conversation, the system of the present invention replaces the word “Mexican” in message 601K with a link 1501 pointing to an advertiser's website. The advertiser may be a provider of Mexican food, thus making the presentation of the advertisement relevant in the context of the current conversation. Clicking on link 1501 may activate a website, open an app to order Mexican food, or perform some other action related to the products and/or services provided by the advertiser. In at least one embodiment, link 1501 may be supplemented by other text to further describe the website that it links to; in at least one embodiment, hovering over, or performing a tap-and-hold operation on link 601K may cause further descriptive information about the link to appear. In at least one embodiment, conversion of text to a link can be performed in addition to any other suitable technique for presenting advertisements; for example, the link may appear within the message along with other embedded advertising text.

### Automatically Shortening Message

In some messaging environments, such as SMS messages, message length may be limited, for example to 160 characters. In at least one embodiment, sender's 100A original message can be automatically shortened to make room for the addition of an advertisement. Users 100 may be given the option to allow or disallow such auto-shortening, and may be given a reward for allowing their messages to be shortened. In at least one embodiment, users may be given control as to the amount of shortening that can take place.

Messages can be shortened, for example, by eliminating unnecessary words and/or by abbreviating some words or phrases. A list of word substitutions can be provided, and automatically applied as appropriate.

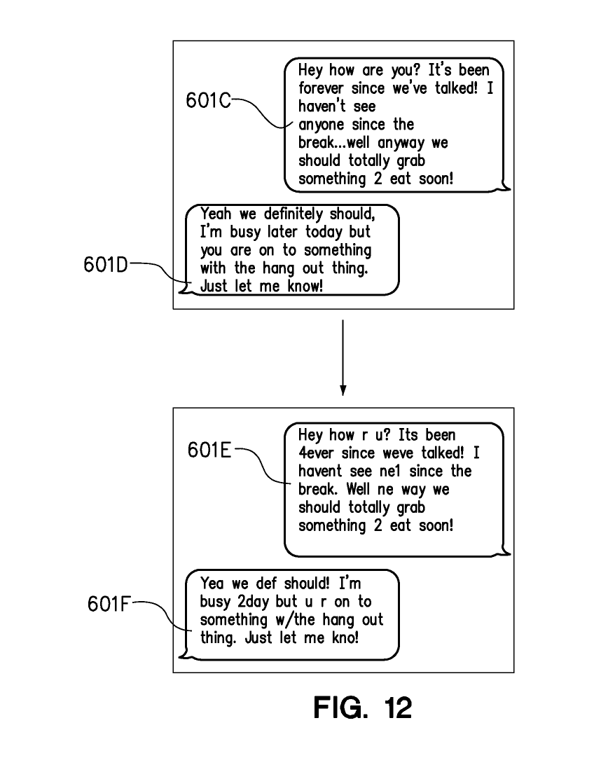

Referring now to FIG. 12, there is shown an example of a technique of automatically shortening a text message to allow an advertisement to be inserted, according to one embodiment of the present invention. Original messages 601C and 601D are automatically replaced by shortened versions 601E and 601F, respectively.

The following is an exemplary list of words and their equivalents, as can be used for automatic shortening of messages:

are=r,

you=u

and=&

be=b

Before=B4

By the way=BTW

Great=GR8

Got to go=GTG

Later=L8R

Love=Luv

Anyone=NE1

Oh I see=OIC

Please=PLS

Someone=SUM1

You are=UR

Thanks=THX

### Automatically Responding to Message by Presenting Advertisement

In at least one embodiment, the system of the present invention can provide localized advertisements in response to messages sent by a user, whether the messages are sent to an ordinary addressee (such as a friend, associate, or other individual) or to a special address or number designated for generating advertisements. For example, an advertiser such as a local business can define a geo-fence (a geographically defined perimeter) around its location; once such a geo-fence has been established, advertisements for that advertiser can be presented in response to relevant text messages (and/or other types of messages) sent by users 100 within the geo-fence.

For example, a Mexican restaurant can define a geo-fence surrounding its location. If a user within the geo-fence sends or receives a message containing the words “Mexican food” or some other relevant string, an advertisement for the Mexican restaurant can be presented. For example, as described above, such an advertisement can be presented within or accompanying a text message received by user 100. Alternatively, such an advertisement can be sent to a user 100 in response to him or her sending a text message containing the words “Mexican food”.

Alternatively, if user 100 is interested in finding a deal that is close to him or her, he or she can send a message to a specific dedicated address or number for serving localized advertisements. In response to such a message, API 202 at server 201 checks whether advertisement database 204 has any relevant advertisements corresponding to the user's current location. Relevance can be determined based on keywords within the message. If any advertisements are found, they can be sent to user 100 via whatever communications channel is appropriate (either the same channel that was used by user 100 to send the query, or some other channel). Examples of such channels include Facebook, Twitter, email, instant message, printed coupon, and the like. The advertisement may contain the name of the advertiser, its location and/or distance from the user's current location, and/or a coupon or discount offer. In at least one embodiment, the discount offer can be presented as a link to a website containing a coupon that can be printed or shown on user's 100 screen 103.

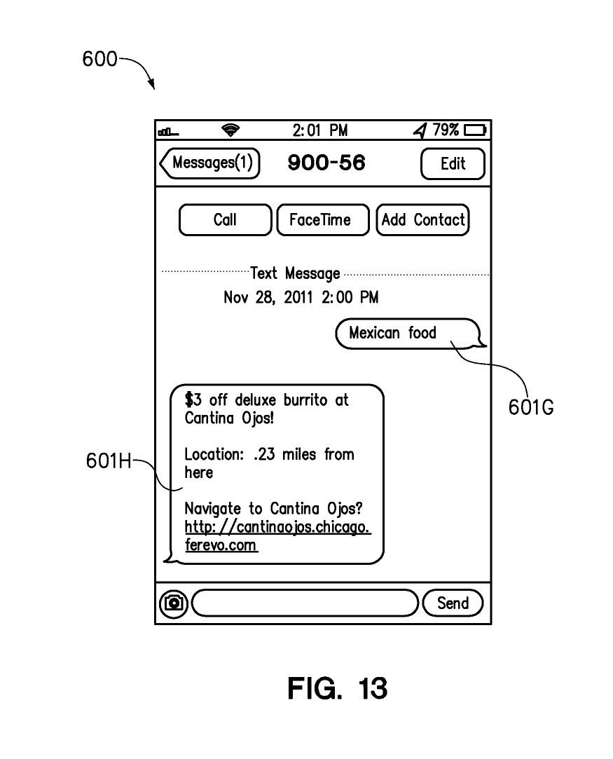

Referring now to FIG. 13, there is shown a screen shot 600, as it might appear on screen 103 of device 101, depicting an example of such a technique of automatically responding to a user's 100 message by presenting an advertisement relevant to keywords found in the message, according to one embodiment of the present invention. Here, user's 100 message is text message 601G containing the phrase “Mexican food”, which has been sent to a designated number for providing advertisements. In response, advertisement 601H is shown, containing the name of the advertiser, its distance from user's 100 current location, a coupon offer, and a link to directions. A similar advertisement might be shown in response to user 100 sending a message containing the phrase “Mexican food” (or a similar phrase) to a friend, associate, or other individual.

### Banner Advertisements

In at least one embodiment, device 101 can present banner advertisements, which may or may not be interactive, in response to the content of a sent or received message, or in response to the subject matter of a conversation. For example, a texting platform can provide the option to display an interactive banner advertisement based on a text conversation user 100 is having with another individual; the banner advertisement can be changed or updated periodically, based on the content of the text conversation.

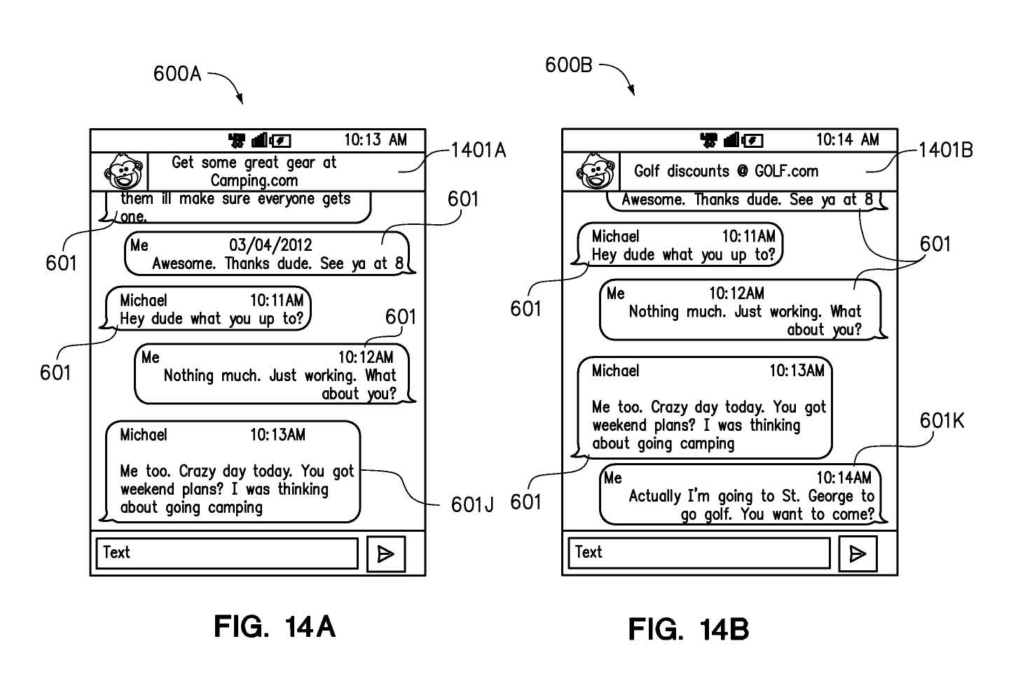

Referring now to FIGS. 14A and 14B, there is shown a series of screen shots 600A, 600B, as they might appear on screen 103 of device 101, depicting an example of a technique of automatically presenting and updating banner advertisements 1401A, 1401B relevant to an ongoing text message conversation, according to one embodiment of the present invention. In the conversation depicted in FIG. 14A, the participants have been discussing camping, as shown in text message 601J; accordingly, the system of the present invention automatically displays banner advertisement 1401A relevant to a camping website offered by an advertiser. As the conversation continues in FIG. 14B, the conversation turns to golf, as shown in text message 601K; accordingly, banner advertisement 1401A is automatically replaced with banner advertisement 1401B relevant to a golf website offered by an advertiser. In this manner, the subject matter of banner advertisement 1401 can be automatically updated, based on analysis of messages 601 being sent and/or received on device 101.

In at least one embodiment, subject matter of banner advertisement 1401 is automatically selected and/or updated based on analysis of messages 601 sent from device 101 at which banner advertisement 1401 is being displayed. In at least one other embodiment, subject matter of banner advertisement 1401 is automatically selected and/or updated based on analysis of messages 601 received at device 101 at which banner advertisement 1401 is being displayed. In at least one other embodiment, subject matter of banner advertisement 1401 is automatically selected and/or updated based on analysis both of messages 601 sent and received at device 101 at which banner advertisement 1401 is being displayed, and/or may take into account the overall context of the text-based conversation.

In at least one embodiment, banner advertisement 1401 can be interactive, so that user 100 can click on banner advertisement 1401 to see more information about the advertised product or service, or to be taken to a webpage with further information, or to purchase the product or service. In various embodiments, banner advertisement 1401 may be dismissed when the message conversation ends, or it may persist after the conversation ends.

In at least one embodiment, the techniques of selecting and displaying banner advertisements 1401 can be combined with the above-described techniques for embedding content, such as advertisements, in text messages. For example, a targeted advertisement can be embedded in a text message based on content of the message, so that the recipient of the message receives the targeted advertisement, while a banner advertisement 1401 is also displayed at the sender's device, based on the content of the same message. In this manner, both the sender and recipient can be presented with relevant advertisements based on the content of the same message. As described above, overall context of the text conversation, including content of previous messages, can be taken into account in selecting the content of the advertisement. In at least one embodiment, the advertisement is presented to that party (or parties) of the conversation that is/are determined to be likely to have an interest in the advertised product or service, while avoiding presenting the advertisement to the other party (or parties) who is/are not likely to have such an interest.

For example, suppose the following exchange between user A and user B, wherein user A is a subscriber to the system of the present invention, so that advertisements can be selected and presented in connection with text messages sent by user A:
1) Message from A to B: “Hey dude, you want to hang out?”
2) Message from B to A: “Can't my headphones broke so I'm heading in to get them fixed.”
3) Message from A to B: “That sucks.”

The system can determine, based on the content of message 1), that user B may be in the market for headphones. However, there is no indication that user A shares such an interest. Accordingly, in an embodiment wherein advertisements are embedded in text messages (as described above), the system of the present invention can add an advertisement related to headphones to message 3), so that the advertisement will be presented to user B and not user A. For example, message 3) may be amended to read “That sucks.—Skullcandy headphones—ferevo.com/asdid”, which includes the name of an online store and a like thereto. This advertisement is relevant to user A, so it is presented to user A.

In another example, suppose a similar exchange, but wherein user B is a subscriber to the system of the present invention, so that advertisements can be selected and presented in connection with text messages sent by user B. Again, the messages read:
1) Message from A to B: “Hey dude, you want to hang out?”
2) Message from B to A: “Can't my headphones broke so I'm heading in to get them fixed.”
3) Message from A to B: “That sucks.”

Here, there is an opportunity to display an advertisement in connection with message 2), since that is the message being sent by the subscriber (user B). However, it would not be productive to embed a headphones-related advertisement in message 2) to user A, since user A has not indicated any interest in headphones (it is user B, not user A, that may be in the market for headphones). Accordingly, in this example, it is more productive to display an advertisement on the sender's (i.e., user B's) device in connection with message 2). Accordingly, as described herein, in at least one embodiment, banner advertisement 1401 is displayed (and/or updated) on user B's screen, containing information about Skullcandy headphones and possibly a link to the appropriate website.

In at least one embodiment, the system of the present invention can also interpret various words and/or phrases in the text-based conversation to determine which party or parties of the conversation may be in the market for, or have an interest in, certain products or services. For example, certain pronouns, names, slangs, and or other elements can be interpreted to refer to the other party in a conversation, thus providing guidance to the system that such party may have a particular interest. For example, suppose the following exchange between user A and user B, wherein user B is a subscriber to the system of the present invention, so that advertisements can be selected and presented in connection with text messages sent by user B:
1) Message from A to B: “Hey dude, you want to hang out?”
2) Message from B to A: “Can't my headphones broke so I'm heading in to get them fixed. Didn't you say that you wanted some new headphones?”

Here, as described above, in at least one embodiment, a headphones-related banner advertisement 1401 is displayed (and/or updated) on user B's screen, since the system can determine that user B may be in the market for headphones. In addition, the second sentence of message 2) indicates that user A may also be interested in headphones; this can be determined by interpreting the pronoun “you” to refer to user B. Accordingly, in at least one embodiment, in addition to presenting headphones-related banner advertisement 1401 on user B's screen, the system of the present invention also embeds a headphones-related advertisement in message 2), so that user A is presented with such headphones-related advertisement. In this manner, both parties are appropriately targeted for headphones-related advertisements.

One skilled in the art will recognize that these examples, and the format, arrangement, and presentation of banner advertisements 1401A, 1401B as shown in FIGS. 14A and 14B, are presented for illustrative purposes only. In particular, advertisements of any suitable type or types can be selected and presented to the various parties of the text-based conversation in many other ways without departing from the essential characteristics of the invention. For example, device 101 can present any type of advertisement whose content is selected responsive to the contents of the message conversation, and such advertisement need not be a banner advertisement. The use of the term “banner advertisement” here is strictly for ease of nomenclature and for illustrative purposes; one skilled in the art will recognize that any other type of advertisement can be presented and/or updated using the techniques described herein. Other types of advertisements can include, without limitation, advertisements having audio components, visual components (static and/or dynamic), animations, videos, images, words, text, links, and/or the like, and/or any combination thereof.

### Automatically Transmitting Supplemental Message or Coupon

In at least one embodiment, clicking or tapping on a link generated according to any of the above-described techniques causes a supplemental message, such as a text message, to be sent to the user 100 that clicked or tapped on the link. The link may be any of the above-described links, such as a link in an embedded advertisement, or text converted to a link, or a link in a separately transmitted advertisement. The supplemental message can be transmitted to the user 100 that clicked or tapped on the link, and/or to other participants in the message conversation, and/or other friends or associates of user 100, and/or any other individuals that are deemed to be potentially interested in the content of the supplemental message. The supplemental message may contain an advertisement and/or any other relevant content. For example, the supplemental message may contain a YouTube video link, a website link, or the like.

Alternatively, the supplemental message may contain a coupon, referred to herein as a text-launch coupon (TLC). The supplemental message can be transmitted using the same mode as the source of the link (e.g., by text message), or by any other suitable mode (e.g., by email).

Thus, in at least one embodiment, when user 100 clicks or taps on a link found in an embedded advertisement, a coupon may be sent to user's 100 inbox. The coupon may contain any suitable text and/or graphics describing the offer terms, the business, and any other relevant information. Example include: specifics of the coupon offer; time of day it is valid; expiration date; the number of people who have redeemed the coupon compared to the number who have received it; links to further information, for example via a web page; and the like. User 100 can then redeem the coupon from the advertiser or other place of business associated with the coupon or advertisement. In some embodiments, sender 100A of the original message may be compensated when recipient 100B of that message receives a coupon and/or redeems a coupon that was accessed via a link in the original message. Such compensation may include points, discounts, and/or any other form of incentive or reward.

For example, and without limitation, sender 100A may receive points that can be exchanged for cash or goods. In at least one embodiment, such points can be redeemed in a special marketplace, such as an online ecommerce site, wherein points are redeemable for merchandise and/or services, donations to charity, and the like.

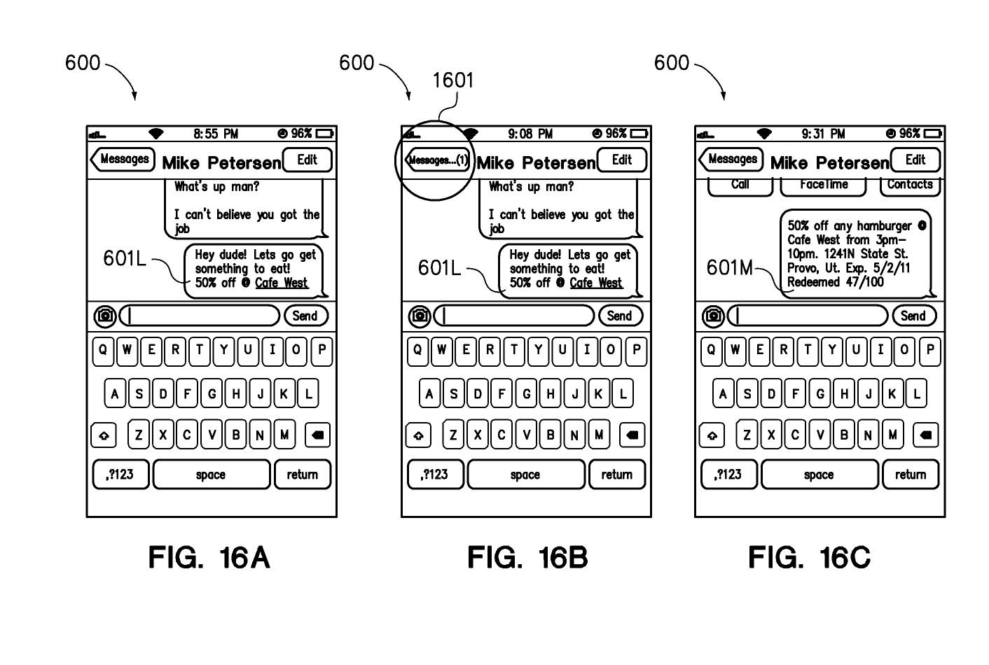

Referring now to FIGS. 16A through 16C, there is shown a series of screen shots 600, as they might appear on screen 103 of device 101, depicting an example of automatically transmitting a supplemental text message advertisement, responsive to a user 100 clicking on a link in an advertisement in a text message, according to one embodiment of the present invention. In FIG. 16A, message 601L is shown on screen 103 as part of a text message conversation. An advertisement, including a hyperlink, has been embedded in message 601L, according to the techniques described above. Here, the advertisement contains descriptive text offering a discount coupon, in addition to a hyperlink.

In FIG. 16B, user 100 has clicked or tapped on the link embedded in message 601L. In response to this action, a new message is automatically sent to user's 100 device 101, as indicated in messages button 1601 which now shows that there is one unread message. User 100 can navigate to the unread message to view it. FIG. 16C depicts screen shot 600, as it might appear on screen 103, after user 100 has navigated to the new message 601M, which provides additional details about the discount coupon and the location of the restaurant.

Such a technique can be relatively unobtrusive, because user 100 can click on the link embedded in message 601L, and the supplemental message is sent to user's 100 inbox (such as a text message inbox, email inbox, or the like). User 100 need not read the supplemental message immediately, but can do so at his or her convenience.

In at least one embodiment, message 601M is automatically transmitted by central server 201 or any other suitable entity, upon receiving a signal indicating that user 100 has tapped or clicked on a hyperlink such as that shown in message 601L.

In at least one embodiment, a button or link in an advertisement can be activated to send an advertisement message to other users 100. The advertisement message may contain an advertisement, video, web content, coupon, and/or any other type of content. In at least one embodiment, the advertisement message is automatically sent to those users 100 with whom the activating user 100 has a relationship, or with whom the activating user 100 is in a conversation. In at least one embodiment, users 100 can opt out, so that they do not receive such advertisement messages.

In at least one embodiment, a coupon can be redeemed using a checkin function as is available on many social networks. For example, the system can detect user's 100 location proximate to or inside a place of business, so as to automatically activate the offer (such as by providing preferable pricing to user 100). Alternatively, user 100 can show the coupon on screen 103 to a cashier, who can scan a machine-readable code included thereon, or can enter a discount manually.

In at least one embodiment, user 100 can be given the opportunity to provide feedback regarding the coupon offer. In at least one embodiment, providing such feedback may result in user 100 being given an opportunity to join a mailing list, particularly if the feedback was positive. In at least one embodiment, such positive feedback may also result in a reward being sent to the original sender 100A of the message that contained the advertisement leading to the coupon.

In at least one embodiment, user 100 can choose to share an advertisement or coupon via user's 100 social network page or by causing the advertisement or coupon to be transmitted to user's 100 “friends” on a social network. Such sharing can take place via email or other communication channel, or by a “share” function as provided by Facebook and other social networks. In at least one embodiment, when an advertisement or coupon has been shared in this manner, other users who click on the link can be asked to join the advertising system (so as to make themselves potential recipients for future advertisements), or to be sent a coupon. Rewards can be sent to user 100 who shared the advertisement or offer in response to such activity on the part of other users.

Alternatively, in at least one embodiment, when a user 100 redeems a coupon, such action is automatically indicated on user's 100 social network page, to inform “friends” of user 100 that the coupon has been redeemed, and perhaps giving those friends an opportunity to see an advertisement for the place of business and/or to receive coupons of their own. Such an arrangement may be useful, particularly in situations where “friends” in a social networking context are likely to have similar interests to one another, thus increasing the likelihood that the coupons will be redeemed if made available to “friends” of a user 100 who was redeemed them. Accordingly, in at least one embodiment, the system of the present invention can automatically post coupon redemptions, check-ins, and/or the advertisement itself to user's 100 social network page. Then, whenever any of user's 100 “friends” or social contacts views user's 100 page, he or she can also see the advertisement and/or be presented with the same (or another relevant) offer. If the “friends” wish to receive the same offer as user 100 received, they may click on the post, which can include the coupon or a link to it. In at least one embodiment, a message can be sent automatically to a “friend” who clicks on the post, wherein such message also includes the offer (or another relevant offer).

In any of these scenarios, user 100 may receive a reward based on a “friend” interacting with the post to view an advertisement and/or receive a coupon. User 100 may also receive a reward when the “friend” redeems and/or activates the reward.

In another embodiment, the coupons may be redeemable in an e-commerce environment. For example, the coupon may contain a promotional code that user 100 can enter at a website, and/or a link that takes user 100 directly to an e-commerce website and offers a discount automatically.

The various types of advertisements depicted herein are merely exemplary. One skilled in the art will recognize that many other types of advertisements may be presented, and that advertisements can be inserted according to any of a number of different techniques.

The particular mechanism and format that are used for embedding an advertisement may be selected in any of a number of different ways. One particular format can be pre-set, changeable by a system operator or other authorized individual. Alternatively, the advertiser can specify the desired format for its advertisements. Alternatively, the user him- or herself (e.g., recipient 100B) can specify a preferred format. Alternatively, different formats can be used for different types of advertisements, subject matter, message, domain, channel, mode, and/or any other factor. For example, in at least one embodiment, a longer form (such as text plus hyperlink) can be used if there is sufficient room in the text message, while a shorter form (such as just text) can be used if there is insufficient room.

### Advertisement Notifications Based on Geo-Fencing

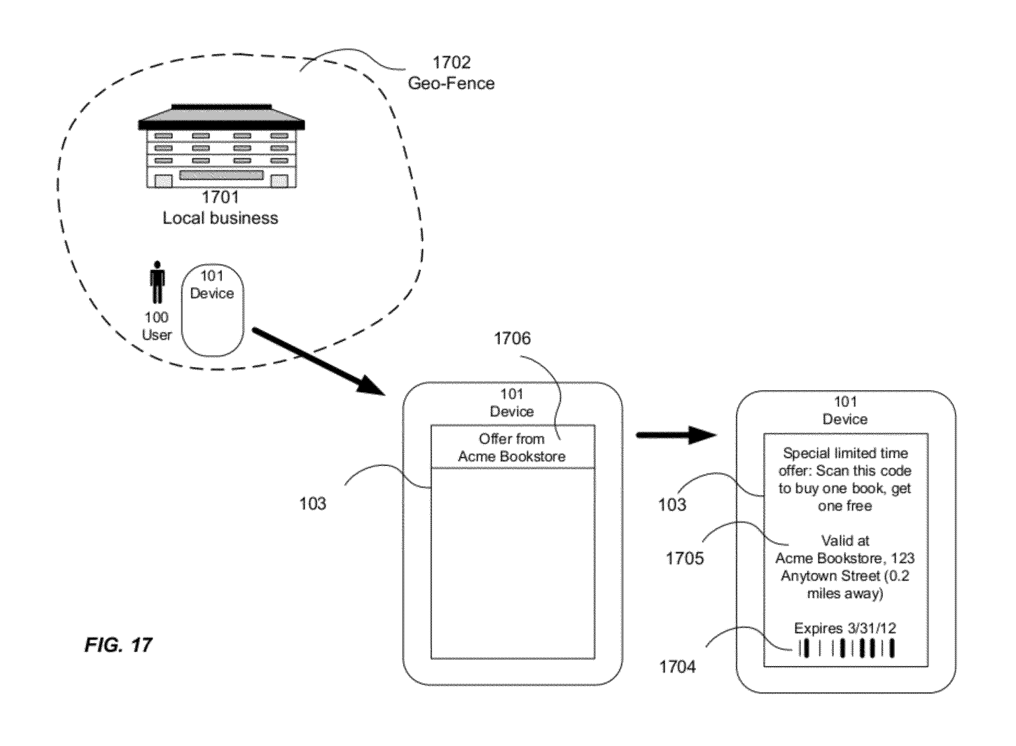

Referring now to FIG. 17, there is shown an example of an advertisement notification based on geo-fencing, according to one embodiment.

In at least one embodiment, once user 100 has activated a link corresponding to a coupon or promotion for a local business 1701, the coupon or promotion can be redeemed using a geo-fencing technique. For example, local business 1701 can define a geo-fence 1702 around a geographic area surrounding the place of business. Users' 100 mobile device 101 can use its GPS capability or other location-sensing capability to determine when it is within the defined geo-fence 1702. A notification message 1706 can then be automatically presented on screen 103 of device 101; notification message 1706 can inform the user 100 of a promotion or offer. User 100 can click on notification message 1706 to see advertisement 1705, containing more details about the promotion or offer. In at least one embodiment, advertisement 1705 includes bar code 1704 or other scannable code that can be used at local business 1701 to redeem the offer.

In at least one embodiment, user 100 can interact with advertisement 1705 to obtain further offers, provide feedback as to the shopping experience, comment on the quality of the advertisement, suggest changes, and the like. In at least one embodiment, user 100 can forward advertisement 1705 to other users. In various embodiments, various techniques can be used for triggering the appearance of notification 1706; for example, including a determination as to geographical proximity to the place of business, device 101 can take into account other factors such as time of day, day of week, current sales or offers, interests of user 100 (as determined by subject matter of past messages, behaviors, or the like), and/or any other factors.

### Privacy Issues

Many of the above-described techniques involve the use of user's 100 personal information. For example, in various embodiments, the system of the present invention may select and present advertisements automatically and based at least in part on known personal information about users 100. The more personal information is shared by users 100, the more effective the selection and tailoring of advertisements. Incentives, such as discounts, credits, and/or cash may be provided to encourage users 100 to share more of their private information. Despite such efforts, however, some individuals may be reluctant to share large amounts of private information.

In at least one embodiment, therefore, the system of the present invention gives users 100 control over many key factors to determine the extent to which private information is made available to the system for use in targeting advertisements.

In at least one embodiment, the system of the present invention uses integration with social networking services (such as Facebook and the like) to receive information about users 100. Thus, those privacy settings that are in place in connection with the social network can apply as well to the advertisement selection system of the present invention.

In at least one embodiment, the system of the present invention may also use a personal information form to receive information about users 100. In at least one embodiment, the system of the present invention may also use surveys or other means to receive information about users 100. From such information, there may be optional key factors that users 100 can control, and there may be mandatory information that the system may control.

Examples of such factors include, without limitation: age, gender, interests, birth date, hobbies, conversation, and the like. Such key factors may be used in the advertisement distribution system's algorithm for tailored advertisements. Users 100 may be given the option of turning particular key factors off; if in the off position, the system of the present invention may, or may not, include them in the advertisement distribution system's algorithm. In this manner, the system can ensure that sensitive personal information is not divulged.

Thus, for example, a user 100 can indicate that his or her location information should be transmitted. Other settings that can be controlled include, for example, restricting the type of advertisements included in text messages, limiting the people to whom advertisements can be sent, limiting the size or character count of advertisements, and the like. In some embodiments, a sender 100A of a message can hide a particular message from the advertisement system of the present invention, for example by adding a symbol such as an asterisk; inclusion of such a symbol in a message causes the system to ignore the message for purposes of analysis in connection with the advertising systems described herein. Thus, the system will not process or analyze the text of such a message, nor will it add an advertisement to such a message. In some embodiments, sender 100A can cause the system to default to such a condition for his or her messages.

### Quick Alert Advertisements

In at least one embodiment, when a coupon or offer is being redeemed, user 100 may be asked to rate the advertisement, coupon, offer, or goods/services provider. For example, user 100 may be asked to indicate his or her satisfaction with the purchase using a five-star rating system. Users 100 who indicate a high level of satisfaction may be prompted to receive alerts from that advertiser, or alerts concerning similar goods/services. Such alerts may include notifications of discounts or promotions that are likely to be of interest to user 100. In other embodiments, other criteria can be used for determining whether to prompt user 100 as to whether he or she wishes to receive alerts.

For example, user 100 may receive a link suggesting a discount for tickets to a local NBA team's game. In response to user 100 clicking on the link, a text message is sent to user's 100 device 101 describing the event and discount offer in greater detail. Upon redeeming the discount offer, user 100 is given an opportunity to rate the quality of the advertisement or product/service. In response to user 100 providing a favorable review (such as five out of five stars), user 100 may then be prompted to receive alerts from the NBA team. If the individual agrees, then in the future, whenever a relevant new offer is available, a text message describing the offer will automatically be sent to user's 100 device 101.

An example of such an alert is as follows:
“Lower Bowl tickets to tonight's Jazz game @ 7:30 for $30. Hurry, only 45 tickets available. Redeem at UtahJazz.com”

### Social Network Integration

In at least one embodiment, the system of the present invention can be integrated with a social network such as Facebook, LinkedIn, Google+, or the like. For example, an extension can be implemented, wherein user 100 can be presented with a list of active and/or expired advertisements, offers, and/or coupons that have been redeemed by that user's 100 “friends” on a particular social network. In at least one embodiment, user 100 can select particular items in the list to receive more information via a link, text message, web page, or some other method.

In at least one embodiment, users 100 can visit a web page to see advertisements, offers, and/or coupons that have been redeemed by their social network “friends”, as well as the ratings provided by others for those advertisements, offers, and/or coupons. In at least one embodiment, users 100 can also see which of their social network “friends” have redeemed which advertisements, offers, and/or coupons. Other information may also be presented, including for example how many advertisements, offers, and/or coupons have been redeemed compared to how many are available, which type of redeeming process (walk-in, e-commerce, or the like) was used, and the like.

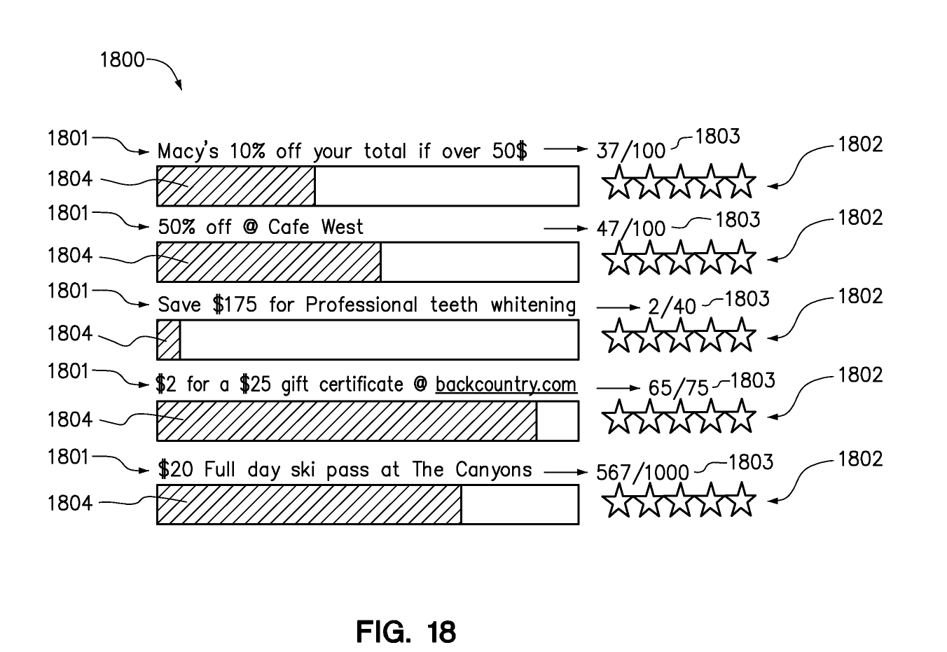

Referring now to FIG. 18, there is shown an example of a display 1800 containing a list of offers 1801 redeemed by “friends” on a social network, as may be presented on a web page or via some other output mechanism, according to one embodiment. For each listed offer 1801, display 1800 shows an average rating 1802 (expressed graphically as a number of stars from zero to five), as well as an indication 1803 of how many “friends” have been presented with the offer and how many have redeemed it. In this example, a graphical indication 1804 indicating the redemption percentage is also included.

In at least one embodiment, the various elements depicted in FIG. 18 are interactive, so that user 100 can click or tap on a listed offer 1801 to see more information, subscribe to it, explore which “friends” have redeemed it, and the like.

One skilled in the art will recognize that the particular layout depicted in FIG. 18 is merely exemplary, and that the list of offers can be presented in any suitable manner, whether graphically, textually, or any combination thereof.

### Ringback Advertisements

In at least one embodiment, the system and method of the present invention provides a mechanism for delivery for audio clip advertisements. A conventional ringback tone is an audible indication that is heard on a telephone line by a caller while the phone they are calling is being rung. According to one embodiment, conventional ringback tones are replaced by audio advertisements. In at least one embodiment, the system of the present invention can select such advertisements based on any known information about the calling party, including for example the content of a text message conversation the calling party might be having (or might recently have had) with an other party.

In at least one embodiment, the audio advertisement may be interactive, in that the user may be prompted to dial a number, or press a button, or say a word or phrase to find out more information or receive an offer. For example, a ringback advertisement may include spoken audio such as “This phone call to ______, is brought to you by ______, (company catch phrase), press “#” for 50% off . . . ”. Well known mechanisms for interpreting DTMF tones and/or speech recognition can be used to interpret the caller's input.

In at least one embodiment, presenting audio advertisements in this manner can be used to partially or completely subsidize costs incurred for minutes with a VoIP service; in other embodiments, revenue generated from such advertisements can be used to enable another form of reward or incentive scheme.

### Analytics

In various embodiments, the system and method of the present invention provide software tools for presenting analytical information concerning presentation of advertisements. For example, and without limitation, a web page may be provided that allows businesses to easily analyze the effectiveness and efficiency of their advertising campaigns including advertisements presented according to the techniques described above. In at least one embodiment, such information is provided to businesses in aggregate form, so as to preserve the privacy of individual consumers.

In various embodiments, such analytics can be presented to indicate exposure and/or response statistics according to any suitable variables, including for example: gender, income, location, time of post-text impression (PTI) how many friends have been shown or have used coupons provided by the system, average advertisement rating, ration between PTIs and coupons, coupon redemption ratio, total PTI, revenue generated from advertisements, number of new clients, how many people have subscribed to an alert, and the like. In various embodiments, the system of the present invention can provide for cross-analysis across any number of variables.

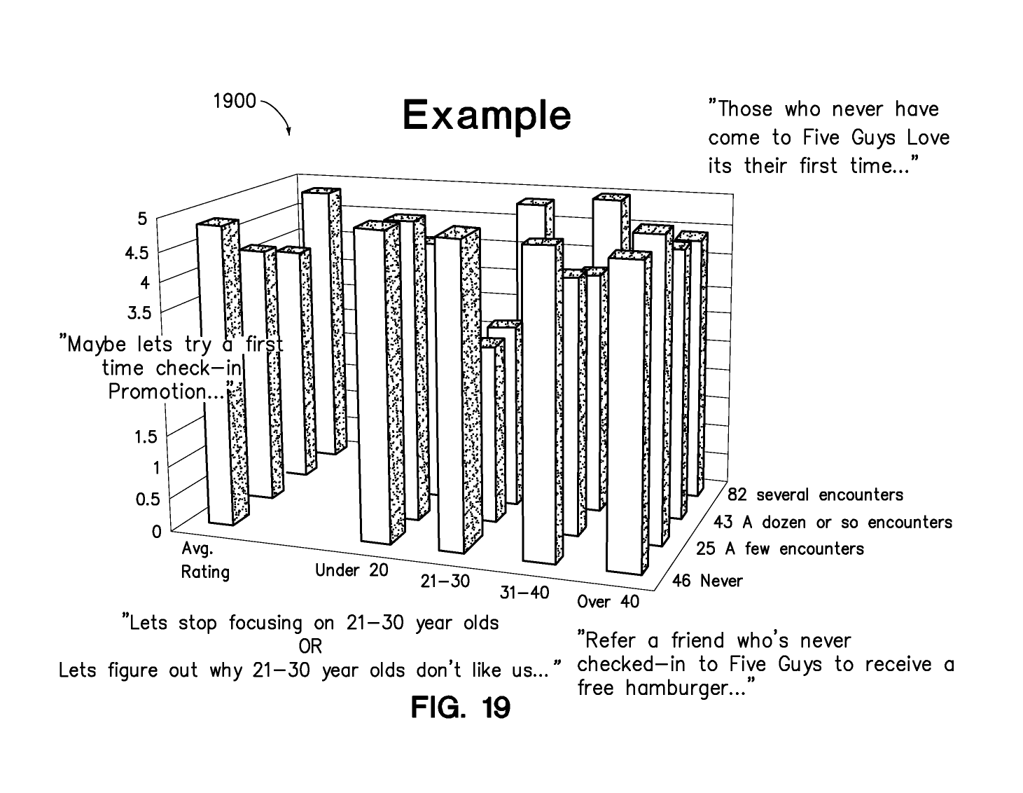

Referring now to FIG. 19, there is shown an example of an analytics report 1900 as presented by a system of the present invention, according to one embodiment. Report 1900 can be presented, for example, on a web page accessible by an advertiser or administrator, or by software running on a computing system of an advertiser or administrator.

One skilled in the art will recognize that the examples depicted and described herein are merely illustrative, and that other arrangements of user interface elements can be used. In addition, some of the depicted elements can be omitted or changed, and additional elements depicted, without departing from the essential characteristics of the invention.

The present invention has been described in particular detail with respect to possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

In various embodiments, the present invention can be implemented as a system or a method for performing the above-described techniques, either singly or in any combination. In another embodiment, the present invention can be implemented as a computer program product comprising a nontransitory computer-readable storage medium and computer program code, encoded on the medium, for causing a processor in a computing device or other electronic device to perform the above-described techniques.

Reference in the specification to “one embodiment” or to “an embodiment” means that a particular feature, structure, or characteristic described in connection with the embodiments is included in at least one embodiment of the invention. The appearances of the phrase “in at least one embodiment” in various places in the specification are not necessarily all referring to the same embodiment or embodiments.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware and/or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

Accordingly, in various embodiments, the present invention can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the invention include: a mobile phone, personal digital assistant, smartphone, kiosk, server computer, enterprise computing device, desktop computer, laptop computer, tablet computer, consumer electronic device, television, set-top box, or the like. An electronic device for implementing the present invention may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View Calif.; and/or any other operating system that is adapted for use on the device.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A computer-implemented method for transmitting an advertisement in connection with an electronic message, comprising:
at a processor, receiving an electronic message, wherein the electronic message was transmitted from a sender and addressed to a designated recipient;
at the processor, selecting an advertisement for inclusion in the electronic message;
at the processor, embedding the selected advertisement within the electronic message; and
transmitting the electronic message, with the embedded advertisement, to the designated recipient via an electronic communications network.

2. The computer-implemented method of claim 1, wherein the electronic message comprises at least one selected from the group consisting of:
an instant message;
a text message;
an SMS message;
an MMS message;
a post to a website; and
a message posted to a social media feed;
a message posted to a Twitter feed; and
a message posted to a Facebook feed.

3. The computer-implemented method of claim 1, wherein the electronic message comprises a text message.

4. The computer-implemented method of claim 1, wherein the electronic message comprises an SMS message.

5. The computer-implemented method of claim 1, wherein:
receiving an electronic message from a sender comprises receiving an electronic message initiated at a mobile device associated with the sender; and
transmitting the electronic message, with the embedded advertisement, to the designated recipient comprises transmitting the electronic message with the embedded advertisement to a mobile device associated with the recipient.

6. The computer-implemented method of claim 1, wherein embedding the selected advertisement within the electronic message comprises appending advertising text to the message.

7. The computer-implemented method of claim 1, wherein the electronic message comprises text, and wherein embedding the selected advertisement within the electronic message comprises converting at least a portion of the text in the electronic message to a hyperlink, the hyperlink comprising a reference to additional information.

8. The computer-implemented method of claim 1, wherein embedding the selected advertisement within the electronic message comprises adding a hyperlink to the electronic message, the hyperlink comprising a reference to additional information.

9. The computer-implemented method of claim 1, wherein embedding the selected advertisement within the electronic message comprises adding a hyperlink to the electronic message, the hyperlink providing access to a coupon.

10. The computer-implemented method of claim 9, further comprising:
receiving an indication that the designated recipient has redeemed the coupon; and
responsive to the indication that the designated recipient has redeemed the coupon, issuing a reward to the sender.

11. The computer-implemented method of claim 1, wherein embedding the selected advertisement within the electronic message comprises adding a hyperlink to the electronic message, wherein activating the hyperlink causes at least one of a supplemental advertisement and a redeemable coupon to be transmitted to the recipient.

12. The computer-implemented method of claim 1, wherein embedding the selected advertisement within the electronic message comprises adding a hyperlink to the electronic message, wherein activating the hyperlink causes a telephone number to be called.

13. The computer-implemented method of claim 1, further comprising:
receiving an indication that the designated recipient has viewed the advertisement; and
responsive to the indication that the designated recipient has viewed the advertisement, issuing a reward to the sender.

14. The computer-implemented method of claim 1, wherein the electronic message comprises text, and wherein selecting an advertisement for inclusion in the electronic message comprises:
at the processor, extracting at least a portion of the text of the electronic message;
at the processor, analyzing the extracted text; and
at the processor, selecting an advertisement based on the content of the extracted text.

15. The computer-implemented method of claim 1, wherein the electronic message is part of an electronic conversation between the sender and the recipient, the electronic conversation comprising a plurality of messages comprising text, and wherein selecting an advertisement for inclusion in the electronic message comprises:
at the processor, extracting at least a portion of the text of the conversation;
at the processor, analyzing the extracted text; and
at the processor, selecting an advertisement based on the content of the extracted text.

16. The computer-implemented method of claim 1, wherein selecting an advertisement for inclusion in the electronic message comprises:
at the processor, obtaining information describing at least one of the sender and the recipient;
at the processor, selecting an advertisement based on the obtained information.

17. The computer-implemented method of claim 1, wherein selecting an advertisement for inclusion in the electronic message comprises:
at the processor, determining a location of at least one of the sender and the recipient;
at the processor, selecting an advertisement based on the determined location.

18. The computer-implemented method of claim 17, wherein selecting an advertisement based on the determined location comprises selecting an advertisement corresponding to a business located proximate to at least one of the sender and the recipient.

19. The computer-implemented method of claim 1, wherein the electronic message comprises an SMS message, and wherein:
receiving an electronic message from a sender comprises receiving the electronic message at an SMS message carrier associated with the sender;
selecting an advertisement for inclusion in the electronic message and embedding the selected advertisement within the electronic message comprises:
transmitting text from the electronic message to a server for analysis thereon; and
receiving, from the server, modified text comprising the embedded advertisement; and
transmitting the electronic message, with the embedded advertisement, to the designated recipient comprises transmitting the electronic message from the SMS message carrier to an SMS message carrier associated with the recipient.

20. The computer-implemented method of claim 1, wherein:
receiving an electronic message from a sender comprises receiving the electronic message from an SMS message carrier associated with the sender;
transmitting the electronic message, with the embedded advertisement, to the designated recipient comprises transmitting the electronic message, with the embedded advertisement, to the SMS message carrier associated with the sender for further transmission to an SMS message carrier associated with the recipient.

21. The computer-implemented method of claim 1, wherein the electronic message comprises a message generated by a messaging app on a device associated with the sender, and wherein:
receiving an electronic message from a sender comprises receiving the electronic message at an app network in communication with the messaging app;
selecting an advertisement for inclusion in the electronic message and embedding the selected advertisement within the electronic message comprises:
transmitting text from the electronic message to a server for analysis thereon; and
receiving, from the server, modified text comprising the embedded advertisement; and
transmitting the electronic message, with the embedded advertisement, to the designated recipient comprises transmitting the electronic message from the app network carrier to an SMS message carrier associated with the recipient.

22. The computer-implemented method of claim 1, wherein:
receiving an electronic message from a sender comprises receiving the electronic message from an app network in communication with a messaging app running on a device associated with the sender;
transmitting the electronic message, with the embedded advertisement, to the designated recipient comprises transmitting the electronic message, with the embedded advertisement, to the app network for further transmission to an SMS message carrier associated with the recipient.

23. The computer-implemented method of claim 1, wherein the electronic message comprises a message generated by a messaging app on a device associated with the sender, and wherein:
receiving an electronic message from a sender comprises receiving the electronic message at an app network in communication with the messaging app;
selecting an advertisement for inclusion in the electronic message and embedding the selected advertisement within the electronic message comprises:
transmitting text from the electronic message to a server for analysis thereon; and
receiving, from the server, modified text comprising the embedded advertisement; and
transmitting the electronic message, with the embedded advertisement, to the designated recipient comprises transmitting the electronic message from the app network carrier to a messaging app on a device associated with the recipient.

24. The computer-implemented method of claim 1, wherein:
receiving an electronic message from a sender comprises receiving the electronic message from an app network in communication with a messaging app running on a device associated with the sender;
transmitting the electronic message, with the embedded advertisement, to the designated recipient comprises transmitting the electronic message, with the embedded advertisement, to the app network for further transmission to a messaging app on a device associated with the recipient.

25. The computer-implemented method of claim 1, wherein:
receiving an electronic message from a sender comprises receiving the electronic message at an app running on a device associated with the sender;
selecting an advertisement for inclusion in the electronic message and embedding the selected advertisement within the electronic message comprises:
transmitting text from the device to a server for analysis thereon; and
receiving, from the server, modified text comprising the embedded advertisement; and
transmitting the electronic message, with the embedded advertisement, to the designated recipient comprises transmitting the electronic message from the device to the recipient.

26. The computer-implemented method of claim 1, wherein:
receiving an electronic message from a sender comprises receiving the electronic message from an app running on a device associated with the sender;
transmitting the electronic message, with the embedded advertisement, to the designated recipient comprises:
transmitting the electronic message, with the embedded advertisement, to the device for further transmission to the recipient.

27. The computer-implemented method of claim 1, further comprising:
removing at least a portion of the electronic message to make room for the selected advertisement.

28. A computer-implemented method for transmitting an advertisement in connection with an electronic message, comprising:
at a processor, receiving an electronic message from a sender, the electronic message having a designated recipient;
at the processor, selecting an advertisement for transmission in connection with the electronic message;
transmitting the electronic message to the designated recipient via an electronic communications network; and transmitting a second electronic message, containing the selected advertisement, to the designated recipient via an electronic communications network.

29. A computer-implemented method for presenting an advertisement on an electronic device, comprising:
at a processor, receiving an indication of a geographically defined region associated with an advertiser;
at the processor, detecting presence of a mobile communication device within the geographically defined region;
in response to detecting presence of the mobile communication device within the geographically defined region, transmitting to the mobile communication device for display thereon, an advertisement associated with the advertiser.

30. The computer-implemented method of claim 29, wherein the transmitted advertisement comprises a coupon redeemable in connection with the advertiser.

31. A computer-implemented method for displaying an advertisement in connection with an electronic message, comprising:
at a processor, receiving an electronic message from a sender, the electronic message having a designated recipient;
at the processor, selecting an advertisement for display based on the received electronic message;
at the processor, determining, based on content of the received electronic message:
a degree of likelihood that the selected advertisement is of interest to the sender; and
a degree of likelihood that the selected advertisement is of interest to the designated recipient; and
responsive to the determined degrees of likelihood, transmitting the selected advertisement to at least one selected from the group consisting of:
a device associated with the sender, for display on such device; and
a device associated with the designated recipient, for display on such device.

32. The computer-implemented method of claim 31, further comprising:
at the processor, receiving at least one additional electronic message from at least one of the sender and the recipient;
at the processor, updating the selected advertisement based on the received electronic message;
transmitting the updated advertisement to at least one selected from the group consisting of:
a device associated with the sender, for display on such device; and
a device associated with the designated recipient, for display on such device.

33. The computer-implemented method of claim 31, wherein transmitting the selected advertisement comprises transmitting the selected advertisement to a device associated with the sender, for display on such device.

34. The computer-implemented method of claim 31, wherein the selected advertisement comprises a banner advertisement.

35. The computer-implemented method of claim 31, wherein the selected advertisement comprises an interactive banner advertisement.

36. The computer-implemented method of claim 31, wherein at least one of the devices displays the selected advertisement concurrently with display of the electronic message.

37. The computer-implemented method of claim 31, wherein the electronic message comprises a text message.

38. The computer-implemented method of claim 31, wherein the electronic message comprises an SMS message.

39. The computer-implemented method of claim 31, wherein the electronic message comprises text, and wherein selecting an advertisement for display comprises:
at the processor, extracting at least a portion of the text of the electronic message;
at the processor, analyzing the extracted text; and
at the processor, selecting an advertisement based on the content of the extracted text.

40. The computer-implemented method of claim 31, wherein the electronic message is part of an electronic conversation between the sender and the recipient, the electronic conversation comprising a plurality of messages comprising text, and wherein selecting an advertisement for display comprises:
at the processor, extracting at least a portion of the text of the conversation;
at the processor, analyzing the extracted text; and
at the processor, selecting an advertisement based on the content of the extracted text.

41. The computer-implemented method of claim 31, wherein selecting an advertisement for display comprises:
at the processor, obtaining information describing at least one of the sender and the recipient;
at the processor, selecting an advertisement based on the obtained information.

42. The computer-implemented method of claim 31, wherein selecting an advertisement for display comprises:
at the processor, determining a location of at least one of the sender and the recipient;
at the processor, selecting an advertisement based on the determined location.

43. A computer program product for including an advertisement in an electronic message, comprising:
a non-transitory computer-readable storage medium; and
computer program code, encoded on the medium, configured to cause at least one processor to perform the steps of:
receiving an electronic message, wherein the electronic message was transmitted from a sender and addressed to a designated recipient;
selecting an advertisement for inclusion in the electronic message;
embedding the selected advertisement within the electronic message; and
causing the electronic message to be transmitted, with the embedded advertisement, to the designated recipient via an electronic communications network.

44. The computer program product of claim 43, wherein the electronic message comprises at least one selected from the group consisting of:
an instant message;
a text message;
an SMS message;
an MMS message;
a post to a website; and
a message posted to a social media feed;
a message posted to a Twitter feed; and
a message posted to a Facebook feed.

45. The computer program product of claim 43, wherein the electronic message comprises text, and wherein the computer program code configured to cause at least one processor to select an advertisement for inclusion in the electronic message comprises computer program code configured to cause at least one processor to perform the steps of:
extracting at least a portion of the text of the electronic message;
analyzing the extracted text; and
selecting an advertisement based on the content of the extracted text.

46. The computer program product of claim 43, wherein the electronic message is part of an electronic conversation between the sender and the recipient, the electronic conversation comprising a plurality of messages comprising text, and wherein the computer program code configured to cause at least one processor to select an advertisement for inclusion in the electronic message comprises computer program code configured to cause at least one processor to perform the steps of:
extracting at least a portion of the text of the conversation;
analyzing the extracted text; and
selecting an advertisement based on the content of the extracted text.

47. The computer program product of claim 43, wherein the computer program code configured to cause at least one processor to select an advertisement for inclusion in the electronic message comprises computer program code configured to cause at least one processor to perform the steps of:
obtaining information describing at least one of the sender and the recipient;
selecting an advertisement based on the obtained information.

48. A computer program product for displaying an advertisement in connection with an electronic message, comprising:
a non-transitory computer-readable storage medium; and
computer program code, encoded on the medium, configured to cause at least one processor to perform the steps of:
receiving an electronic message from a sender, the electronic message having a designated recipient;
selecting an advertisement for display based on the received electronic message;
determining, based on content of the received electronic message:
a degree of likelihood that the selected advertisement is of interest to the sender; and
a degree of likelihood that the selected advertisement is of interest to the designated recipient; and
responsive to the determined degrees of likelihood, transmitting the selected advertisement to at least one selected from the group consisting of:
a device associated with the sender, for display on such device; and
a device associated with the designated recipient, for display on such device.

49. A system for including an advertisement in an electronic message, comprising:
a processor, configured to perform the steps of:
receiving an electronic message, wherein the electronic message was transmitted from a sender and addressed to a designated recipient;
selecting an advertisement for inclusion in the electronic message; and
embedding the selected advertisement within the electronic message; and
a transmission device, communicatively coupled to the processor, configured to transmit the electronic message, with the embedded advertisement, to the designated recipient via an electronic communications network.

50. The system of claim 49, wherein the electronic message comprises at least one selected from the group consisting of:
an instant message;
a text message;
an SMS message;
an MMS message;
a post to a website; and
a message posted to a social media feed;
a message posted to a Twitter feed; and
a message posted to a Facebook feed.

51. The system of claim 49, wherein the electronic message comprises text, and wherein the processor is configured to select an advertisement for inclusion in the electronic message by:
extracting at least a portion of the text of the electronic message;
analyzing the extracted text; and
selecting an advertisement based on the content of the extracted text.

52. The system of claim 49, wherein the electronic message is part of an electronic conversation between the sender and the recipient, the electronic conversation comprising a plurality of messages comprising text, and wherein the processor is configured to select an advertisement for inclusion in the electronic message comprises computer program code by:
extracting at least a portion of the text of the conversation;
analyzing the extracted text; and
selecting an advertisement based on the content of the extracted text.

53. The system of claim 49, wherein the processor is configured to select an advertisement for inclusion in the electronic message by:
obtaining information describing at least one of the sender and the recipient;
selecting an advertisement based on the obtained information.

54. A system for displaying an advertisement in connection with an electronic message, comprising:
a processor, configured to perform the steps of:
receiving an electronic message from a sender, the electronic message having a designated recipient;
selecting an advertisement for display based on the received electronic message; and
determining, based on content of the received electronic message:
a degree of likelihood that the selected advertisement is of interest to the sender; and
a degree of likelihood that the selected advertisement is of interest to the designated recipient; and
a transmission device, communicatively coupled to the processor, configured to transmit the selected advertisement to at least one selected from the group consisting of:
a device associated with the sender, for display on such device; and
a device associated with the designated recipient, for display on such device.
